(19) United States
(12) Patent Application Publication
(10) Pub. No.: US 2025/0191510 A1
(43) Pub. Date: Jun. 12, 2025

(54) ELECTRONIC DEVICE AND CONTROLLING METHOD THEREOF

(71) Applicant: Samsung Electronics Co., Ltd., Suwon-si (KR)

(72) Inventors: Taegyoung AHN, Suwon-si (KR); Hwaseok SEONG, Suwon-si (KR)

(21) Appl. No.: 19/056,261

(22) Filed: Feb. 18, 2025

Related U.S. Application Data
(63) Continuation of application No. PCT/KR2023/014278, filed on Sep. 20, 2023.

(30) Foreign Application Priority Data
Nov. 10, 2022 (KR) 10-2022-0149971

(51) Int. Cl. G09G 3/20; G06T 7/00

(52) U.S. Cl. CPC G09G 3/2007; G06T 7/001; G06T 2207/30121; G09G 2320/0233; G09G 2320/0271; G09G 2340/14; G09G 2340/16; G09G 2360/16

(57) ABSTRACT

An example electronic device may include a display, memory storing a plurality of sample images and at least one processor configured to receive a control command for outputting a third gradation value which is greater than a preset first gradation value and less than a preset second gradation value, identify a sample image corresponding to the third gradation value from among the plurality of sample images, and control the display to display the identified sample image, and the sample image includes a first frame including a plurality of pixels arranged based on first arrangement information and a second frame including a plurality of pixels arranged based on second arrangement information, the first arrangement information and the second arrangement information include a position of a first type pixel corresponding to the first gradation value and a position of a second type pixel corresponding to the second gradation value, and the third gradation value is an average value of the a gradation value of the first frame and a gradation value of the second frame.

### CROSS-REFERENCE TO RELATED APPLICATIONS

This application is a continuation of International Application No. PCT/KR2023/014278 designating the United States, filed on Sep. 20, 2023, in the Korean Intellectual Property Receiving Office and claiming priority to Korean Patent Application No. 10-2022-0149971, filed on Nov. 10, 2022, in the Korean Intellectual Property Office, the disclosures of each of which are incorporated by reference herein in their entireties.

### BACKGROUND

### Field

The present disclosure relates to an electronic device and a controlling method thereof, and more particularly, to an electronic device for correcting a gradation value of a display and a controlling method thereof.

### Description of Related Art

A gradation value or a color value can be assigned to each pixel or each display element. Gradation values may be expressed as a first gradation value up to the 256th gradation value. Alternatively, the gradation values may be expressed as 0 to 255th gradation values. Here, the gradation value 0 may represent the darkest gradation level, and the gradation value 255 may represent the brightest gradation information. Meanwhile, the color value may be one of red (R), green (G) and blue (B).

The pixels included in an input image may include gradation values of 0 to 255, and the display elements of a display may output gradation values of 0 to 255. However, due to hardware errors in a display device, the gradation values included in the input image may appear different to the eyes of an actual user. Thus, it may be necessary to inspect the elements of the display. For inspection, a sample image displayed through the display may be captured. The captured image may include a sample image displayed through the display.

The camera that captures the image may play the same role as the user's eyes, but the camera does not have the same high precision as the user's eyes. Accordingly, for a low-gradation image, there may be misrecognition.

If a correction operation is performed based on the captured image including a sample image in a low-gradation range, there may be poor correction performance.

### SUMMARY

Various example embodiments of the present disclosure can provide an electronic device that displays a specific sample image according to a control command for outputting a gradation value included in a threshold range and a controlling method thereof.

An electronic device according to various embodiments may include a display, memory storing a plurality of sample images and at least one processor configured to receive a control command for outputting a third gradation value which is greater than a preset first gradation value and less than a preset second gradation value, identify a sample image corresponding to the third gradation value from among the plurality of sample images, and control the display to display the identified sample image, wherein the sample image includes a first frame including a plurality of pixels arranged based on first arrangement information and a second frame including a plurality of pixels arranged based on second arrangement information, wherein the first arrangement information and the second arrangement information include a position of a first type pixel corresponding to the first gradation value and a position of a second type pixel corresponding to the second gradation value, and wherein the third gradation value is an average value of the a gradation value of the first frame and a gradation value of the second frame.

In an example embodiment, the first gradation value may be a minimum gradation value outputtable through the display, and the second gradation value may be a minimum gradation value correctable through a camera that captures the sample image.

In an example embodiment, the memory may be configured to store a mapping table indicating a sample image corresponding to each of a plurality of gradation values, and at least one processor may be configured to, based on a control command for outputting the third gradation value being received, identify the sample image corresponding to the third gradation value based on the mapping table.

In an example embodiment, at least one processor may be configured to control the display to display the first frame, and based on a preset time elapsing from a time when the first frame is displayed, control the display to display the second frame.

In an example embodiment, the at least one processor may be configured to, based on a user control command for correcting a gradation value being received, control the display to sequentially display a sample image corresponding to each of a plurality of gradation values which are greater than the preset first gradation value and less than the preset second gradation value.

In an example embodiment, the gradation value of the first frame may be an average gradation value of a plurality of pixels included in the first frame, and the gradation value of the second frame may be an average gradation value of a plurality of pixels included in the second frame.

In an example embodiment, the sample image may be an image in which a position of the first type pixel included in the first frame and a position of the first type pixel included in the second frame are different.

In an example embodiment, the device may further include a communication interface (including, e.g., communication interface circuitry) configured to perform communication with an external device, and at least one processor may be configured to receive a captured image including the sample image from the external device through the communication interface, obtain a gradation value of a first pixel group arranged at a first position based on the sample image, obtain a gradation value of a second pixel group arranged at the first position based on the captured image, and correct a gradation setting value of the display by comparing a gradation value obtained from the sample image and a gradation value obtained from the captured image.

In an example embodiment, the at least one processor may be configured to obtain a difference value between a gradation value of the first pixel group obtained from the captured image and a gradation value of the second pixel group obtained from the sample image, and, based on the difference value being equal to or greater than a threshold value, obtain a correction filter for changing a gradation value of a pixel group of the first position based on the difference value.

In an example embodiment, at least one processor may be configured to, based on a user input for displaying an input image being received, correct the input image by changing a gradation value of a third pixel group arranged at the first position of the input image based on the correction filter, and control the display to display the corrected input image.

A controlling method of an electronic device that stores a plurality of sample images according to various embodiments includes receiving a control command for outputting a third gradation value which is greater than a preset first gradation value and less than a preset second gradation value, identifying a sample image corresponding to the third gradation value from among the plurality of sample images, and displaying the identified sample image, wherein the sample image includes a first frame including a plurality of pixels arranged based on first arrangement information and a second frame including a plurality of pixels arranged based on second arrangement information, wherein the first arrangement information and the second arrangement information include a position of a first type pixel corresponding to the first gradation value and a position of a second type pixel corresponding to the second gradation value, and wherein the third gradation value is an average value of the a gradation value of the first frame and a gradation value of the second frame.

In an example embodiment, the first gradation value may be a minimum gradation value outputtable through a display of the electronic device, and the second gradation value may be a minimum gradation value correctable through a camera that captures the sample image.

In an example embodiment, the electronic device may be configured to store a mapping table indicating a sample image corresponding to each of a plurality of gradation values, and the identifying a sample image may include, based on a control command for outputting the third gradation value being received, identifying the sample image corresponding to the third gradation value based on the mapping table.

In an example embodiment, the displaying the sample image may include displaying the first frame, and based on a preset time elapsing from a time when the first frame is displayed, displaying the second frame.

In an example embodiment, the controlling method may further include, based on a user control command for correcting a gradation value being received, sequentially displaying a sample image corresponding to each of a plurality of gradation values which are greater than the preset first gradation value and less than the preset second gradation value.

In an example embodiment, the gradation value of the first frame may be an average gradation value of a plurality of pixels included in the first frame, and the gradation value of the second frame may be an average gradation value of a plurality of pixels included in the second frame.

In an example embodiment, the sample image may be an image in which a position of the first type pixel included in the first frame and a position of the first type pixel included in the second frame are different.

In an example embodiment, the controlling method may include receiving a captured image including the sample image from an external device, obtaining a gradation value of a first pixel group arranged at a first position based on the sample image, obtaining a gradation value of a second pixel group arranged at the first position based on the captured image, and correcting a gradation setting value of a display of the electronic device by comparing a gradation value obtained from the sample image and a gradation value obtained from the captured image.

In an example embodiment, the controlling method may include obtaining a difference value between a gradation value of the first pixel group obtained from the captured image and a gradation value of the second pixel group obtained from the sample image, and, based on the difference value being equal to or greater than a threshold value, obtaining a correction filter for changing a gradation value of a pixel group of the first position based on the difference value.

In an example embodiment, the controlling method may include, based on a user input for displaying an input image being received, correcting the input image by changing a gradation value of a third pixel group arranged at the first position of the input image based on the correction filter, and displaying the corrected input image.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device according to various embodiments;

FIG. 2 is a block diagram illustrating an example configuration of the electronic device of FIG. 1;

FIG. 3 is a view for explaining spatial dithering according to various embodiments;

FIG. 4 is a view for explaining spatial dithering according to various embodiments;

FIG. 5 is a view for explaining temporal dithering according to various embodiments;

FIG. 6 is a view for explaining temporal dithering according to various embodiments;

FIG. 7 is a view for explaining spatial-temporal dithering according to various embodiments;

FIG. 8 is a view for explaining spatial-temporal dithering according to various embodiments;

FIG. 9 is a view for explaining explain an average gradation value according to various embodiments;

FIG. 10 is a view for explaining an average gradation value according to various embodiments;

FIG. 11 is a view for explaining an average gradation value according to various embodiments;

FIG. 12 is a view for explaining an average gradation value according to various embodiments;

FIG. 13 is a view for explaining an average gradation value according to various embodiments;

FIG. 14 is a view for explaining a sample image corresponding to a gradation value;

FIG. 15 is a view for explaining an operation of generating a pixel group of size 4*4 using a pixel group of size 2*2;

FIG. 16 is a view for explaining a difference in perception of dither noise;

FIG. 17 is a view for explaining a system including an electronic device and an external device;

FIG. 18 is a flowchart illustrating an example operation of generating a correction filter;

FIG. 19 is a flowchart illustrating an example operation of displaying a corrected input image;

FIG. 20 is a flowchart illustrating an example operation of an electronic device generating a correction filter according to various embodiments;

FIG. 21 is a flowchart illustrating an example operation of an external device generating a correction filter according to various embodiments;

FIG. 22 is a flowchart illustrating an example operation of a server generating a correction filter according to various embodiments;

FIG. 23 illustrates an example operation of comparing a sample image and a captured image according to various embodiments;

FIG. 24 illustrates an example operation of comparing a sample image and a captured image according to various embodiments; and

FIG. 25 is a flowchart illustrating an example controlling method of an electronic device according to various embodiments.

### DETAILED DESCRIPTION

Hereinafter, the present disclosure will be described in greater detail with reference to the accompanying drawings.

General terms that are currently widely used are selected as the terms used in the example embodiments of the disclosure in consideration of their functions in the disclosure, but may be changed based on the intention of those skilled in the art or a judicial precedent, the emergence of a new technique, or the like. In addition, in a specific case, terms arbitrarily chosen by an applicant may exist, in which case, the meanings of such terms will be described in detail in the corresponding descriptions of the disclosure. Thus, the terms used in the example embodiments of the disclosure need to be defined on the basis of the meanings of the terms and the overall contents throughout the disclosure rather than simple names of the terms.

In the disclosure, the expressions “have”, “may have”, “include” or “may include” indicate existence of corresponding features (e.g., components such as numeric values, functions, operations, or components), but do not exclude presence of additional features.

An expression, “at least one of A or/and B” should be understood as indicating any one of “A”, “B” and “both of A and B.”

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

Singular expressions include plural expressions unless the context clearly dictates otherwise. In this specification, terms such as “comprise” or “have” are intended to designate the presence of features, numbers, steps, operations, components, parts, or a combination thereof described in the specification, but are not intended to exclude in advance the possibility of the presence or addition of one or more of other features, numbers, steps, operations, components, parts, or a combination thereof.

In example embodiments, a “module” or a “unit” may perform at least one function or operation, and be implemented as hardware or software or be implemented as a combination of hardware and software. In addition, a plurality of “modules” or a plurality of “units” may be integrated into at least one module and be implemented as at least one processor (not shown) except for a ‘module’ or a ‘unit’ that needs to be implemented as specific hardware.

In this specification, the term ‘user’ may refer to a person using an electronic device or an apparatus using an electronic device (e.g., an artificial intelligence electronic device).

Hereinafter, example embodiments of the present disclosure will be described in greater detail with reference to the accompanying drawings.

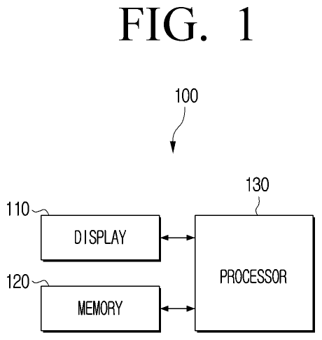

FIG. 1 is a block diagram illustrating an example electronic device according to various embodiments.

Referring to FIG. 1, an electronic device 100 may include at least one of a display 110, memory 120, or at least one processor 130 (including, e.g., processing circuitry).

The at least one processor 130 may be a device that includes the display 110.

The display 110 may output a sample image.

The memory 120 may store a plurality of sample images.

The at least one processor 130 may receive a control command for outputting a third gradation value that is above a preset first gradation value and below a preset second gradation value, may identify a sample image corresponding to the third gradation value from among the plurality of sample images, and may control the display 110 to display the identified sample image. The sample image may include a first frame including a plurality of pixels arranged based on first arrangement information and a second frame including a plurality of pixels arranged based on second arrangement information. The first arrangement information and the second arrangement information may include a position of a first type pixel corresponding to a first gradation value or a position of a second type pixel corresponding to a second gradation value. The third gradation value may be an average of the gradation value of the first frame and the gradation value of the second frame.

The at least one processor 130 may output a sample image through a display including a plurality of display elements. By outputting the sample image, the at least one processor 130 may examine (or test) the gradation value output performance of the display elements. When there is a problem (or error) with the gradation value output performance of a particular display element, the gradation value included in the control command and the output gradation value may differ. A display element may refer, for example, to an element that emits light to output an image signal on a display. The display element may be described as a pixel element or a light-emitting element.

The sample image may be an image for examining (or testing) a particular gradation value. Further, each of the sample images may include at least one frame. The frame may be a concept for separating images in a chronological order. For example, a first frame may be an image displayed at a first point in time, and a second frame may be an image displayed at a second point in time. The frame and the image can be described interchangeably.

In that a sample image includes a plurality of frames, the sample image can be represented as a group of sample images.

The sample image may be an image for examining a specific range of gradation values. The specific range may be above a first gradation value and below a second gradation value.

The first gradation value may be, for example, a minimum gradation value that can be output through the display 110, and the second gradation value may be, for example, a minimum gradation value that can be corrected through the camera capturing the sample image.

The second gradation value may be, for example, a gradation value associated with the camera obtaining the captured image. The second gradation value may be, for example, a minimum gradation value among the gradation values that are normally recognizable by the camera. ‘Normally recognizable’ may refer to, for example, the gradation value obtained through the captured image and the gradation value included in the output command being the same. In a case of low gradation (or a preset gradation range), there may be a difference in the gradation value obtained from the captured image and the gradation value included in the actual output command.

It is assumed that the low gradation is a specific range of gradations, and that the gradation values included in the low gradation cannot be corrected through the camera. The second gradation value may refer to a minimum value among the gradation values that do not fall in the specific range.

Thus, the range of low gradation may vary depending on the camera.

Accordingly, the second gradation value may refer to, for example, the minimum value among the gradation values that the camera obtaining the captured image does not determine to be low gradation.

It is not the case that gradation values lower than the second gradation value are not obtained at all through the captured image. However, even if there is no hardware problem in the display element, there may be a difference between the gradation values obtained through the captured image and the actual gradation values.

For example, it is assumed that there are 256 gradation values. There may be misrecognition for gradation values 1 to 63 among the 256 gradation values. For example, when capturing gradation value 64, pixels with gradation value 64 may be clearly identified in the captured image.

However, when gradation value 63 is captured, pixels with gradation value 63 may not be clearly identified in the captured image. Thus, there is a problem that the examination results for gradation values corresponding to a specific range (gradation values of 1 to 63) corresponding to low gradation are not accurate.

Meanwhile, the specific range may change depending on the performance of the camera, the resolution of the image, and/or the illuminance of the surrounding environment. In other words, the second gradation value may change based on at least one of the performance of the camera, the resolution of the captured image, or the illuminance of the surrounding environment.

The sample image may include a plurality of pixels arranged based on arrangement information. The arrangement information may include a structure of pixel values included in the sample image. The pixel values may include, for example, at least one of a gradation value or a color value. The arrangement information may include an array of gradation values for each of the pixels included in the sample image. The arrangement information may include information about which gradation value is assigned based on the position of a pixel included in the image. Accordingly, the arrangement information may be described, for example, as pixel information or gradation information.

For example, it is assumed that there is an image of size 2*2. The arrangement information may include the gradation value of pixel (1,1), the gradation value of pixel (1,2), the gradation value of pixel (2,1), and the gradation value of pixel (2,2).

Meanwhile, the sample image may include only the first gradation value or only the second gradation value. Since it is difficult for the camera to recognize a gradation value corresponding to a low gradation, the at least one processor 130 may use a sample image that includes only the first and second gradation values. The pixel representing the first gradation value may be described, for example, as a first type pixel, and the pixel representing the second gradation value may be described, for example, as a second type pixel. The arrangement information may include a position of the first type pixel and a position of the second type pixel.

For example, when the first gradation value is 0 and the second gradation value is 64, the sample image may include only the first type pixel with gradation value 1 and the second type pixel with gradation value 64.

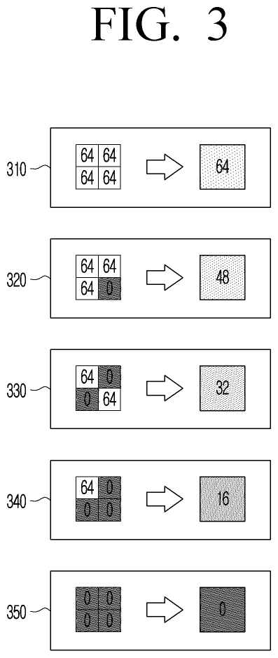

For example, in the example 330 of FIG. 3, the positions of the first type pixel may be (1,2) and (2,1), and the positions of the second type pixel may be (1,1) and (2,2).

The at least one processor 130 may store in the memory 120 a sample image corresponding to each gradation value of a preset range (values above the first gradation value to values below the second gradation value). The sample image may be a preset image.

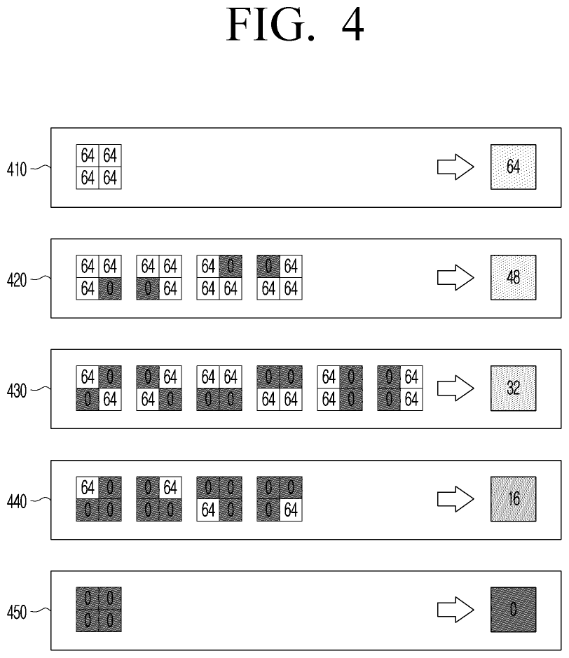

In addition, the arrangement information may be implemented in various forms for spatial dithering. For example, there may be multiple arrangement information to represent one average gradation value. FIGS. 3 and 4 will be referenced to describe an example of spatial dithering.

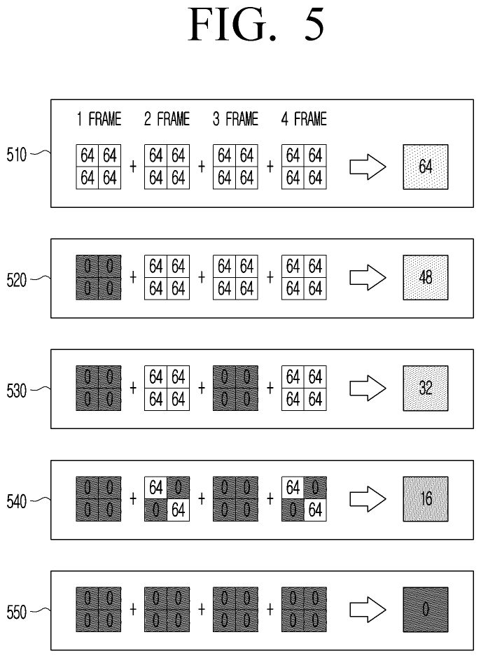

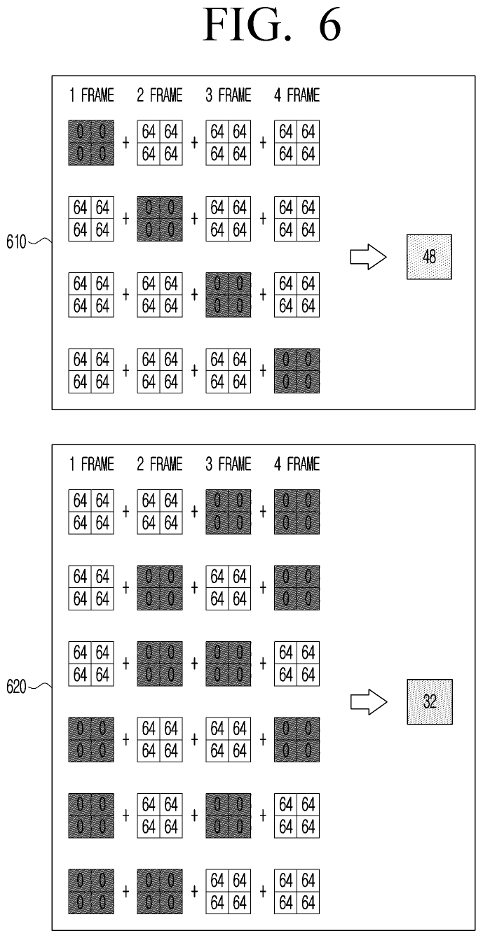

The sample image may include a first frame and a second frame. The first frame may be an image output at a first time point, and the second frame may be an image output at a second time point. For temporal dithering, the sample image may include a plurality of frames. FIGS. 5 and 6 will be referenced to describe an example of temporal dithering.

The at least one processor 130 may receive a user input for generating a correction filter. The correction filter may generate a correction filter to be applied to an input image displayed on the electronic device 100. A correction filter is necessary because the display elements included in the display may themselves have hardware errors. Depending on a minute error occurring during the factory manufacturing process, the gradation value output performance of the display element may be relatively high or low. Thus, the at least one processor 130 may correct the error through the correction filter.

When a user input for generating a correction filter is received, the at least one processor 130 may perform a check on a plurality of gradation values. Specifically, the at least one processor 130 may perform a check on a plurality of gradation values that can be output through the display 110. The at least one processor 130 may output a general image or a sample image based on the range of gradation values.

Upon receiving a command for generating a correction filter, the at least one processor 130 may output an image for testing the at least one gradation value. One gradation value to be tested among the at least one gradation value may be described as a target gradation value. Further, the target gradation value may be, for example, a third gradation value.

For gradation values in a preset range (above the first gradation value and below the second gradation value), the at least one processor 130 may output a sample image corresponding to the target gradation value.

For gradation values which are not within the preset range, the at least one processor 130 may output a general image corresponding to the target gradation value.

The general image may be an image in which all pixels constituting the image have the same gradation value (target gradation value). For example, when gradation value 65 is being tested, the at least one processor 130 may display a general image in which all pixels have gradation value 65.

The sample image may be an image in which the pixels constituting the image include only the first and second gradation values to represent the target gradation values.

The reason for distinctively naming the general image and the sample image is to clearly distinguish images for representing low gradation. Depending on the expression method, the general image may also be expressed in the same way as the sample image since the general image can be displayed for inspection. The general image may be described, for example, as a first type image or a first type sample image, and the sample image may be described, for example, as a second type image or a second type sample image.

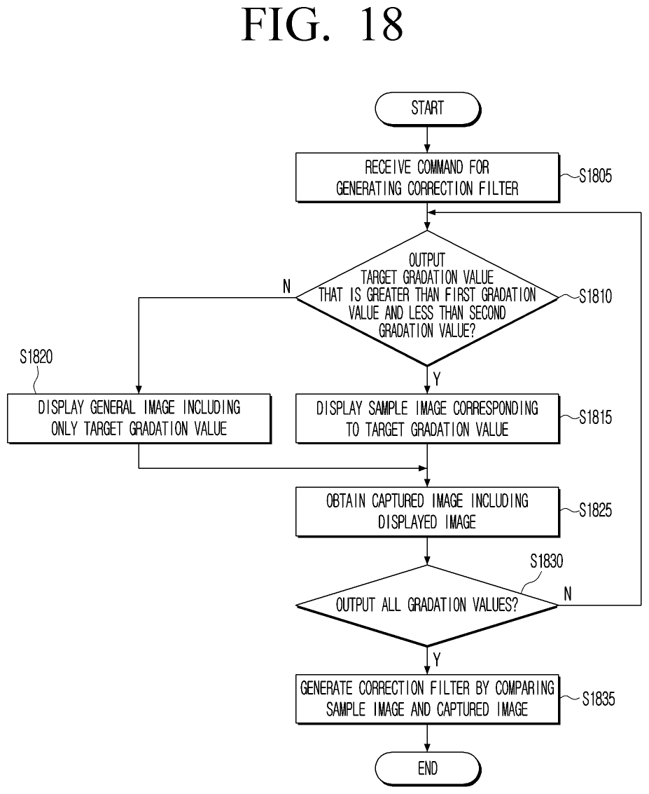

A detailed description thereof will be provided with reference to FIG. 18.

The third gradation value may refer to, for example, a target gradation value for inspection. When the third gradation value is above the first gradation value and below the second gradation value, the at least one processor 130 may identify a sample image corresponding to the third gradation value. Subsequently, the at least one processor 130 may output the identified sample image through the display 110. Here, the sample image may be an image corresponding to the third gradation value.

The sample image may include a first frame and a second frame. The third gradation value corresponding to the sample image may be an average value of the gradation value of the first frame and the gradation value of the second frame.

For example, applying the example 520 of FIG. 5, it is assumed that the third gradation value (target gradation value) is 48. The sample image may include frames 1 to 4. The average gradation value for the first frame may be 0, and the average gradation value for the second to fourth frame may be 64. The average value of the average gradation value for each frame may be 48. Thus, the average value of the average gradation value for each frame may be the same as the target gradation value (the third gradation value).

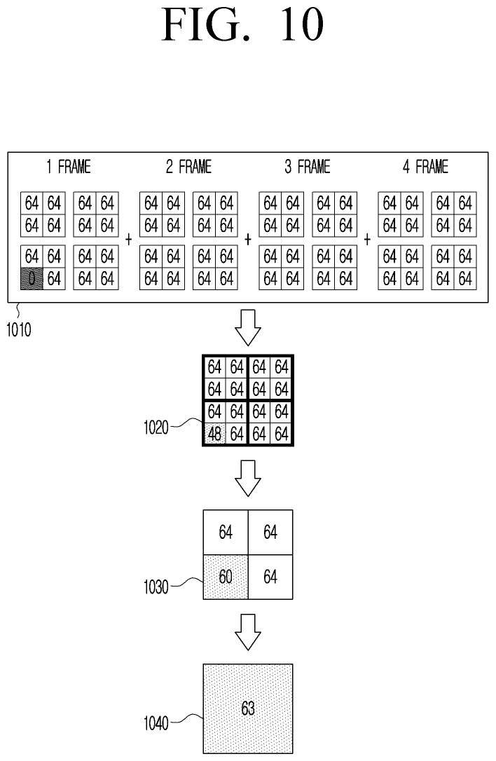

For example, applying the embodiment of FIG. 10, it is assumed that the third gradation value (target gradation value) is 63. The sample image may include frames 1 to 4. The first frame may have an average gradation value of 60, and the second to fourth frames may have an average gradation value of 64. The average value of the average gradation value for each frame may be 63. Thus, the average value of the average gradation value for each frame may be the same as the target gradation value (the third gradation value).

Meanwhile, the memory 120 may store a mapping table representing a sample image corresponding to each of the plurality of gradation values, and the at least one processor 130 may, upon receiving a control command for outputting the third gradation value, identify a sample image corresponding to the third gradation value based on the mapping table, and control the display 110 to display the identified sample image.

The mapping table may include information in which the gradation values and the sample images are mapped. For example, the mapping table may include first mapping information in which gradation value 1 and a sample image corresponding to gradation value 1 are mapped, and second mapping information in which gradation value 2 and a sample image corresponding to gradation value 2 are mapped.

According to various embodiments, the mapping table may include sample images for gradation values in a preset range (above the first gradation value and below the second gradation value). For example, the mapping table may include a sample image corresponding to each of gradation value 1 to gradation value 63.

According to various embodiments, the mapping table may include sample images for gradation values in a preset range (above the first gradation value and below the second gradation value) and general images for gradation values which do not fall within the preset range. For example, the mapping table may include a sample image corresponding to each of gradation value 1 to gradation value 63, and the mapping table may include a general image corresponding to each of gradation value 0 and gradation value 64 to gradation value 255.

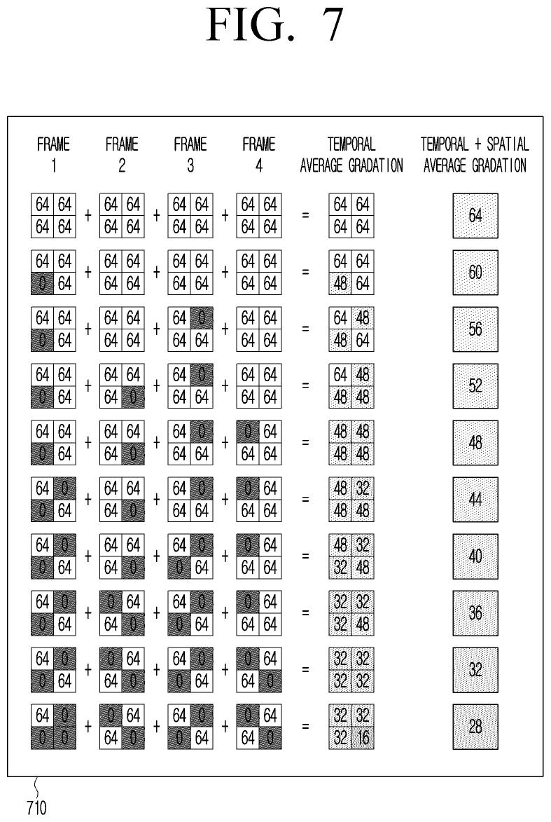

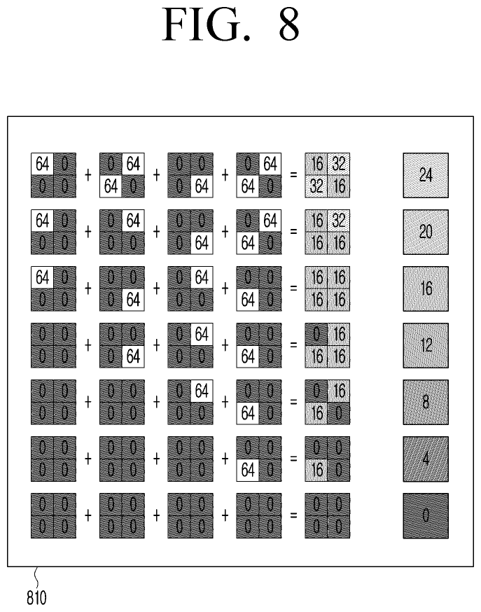

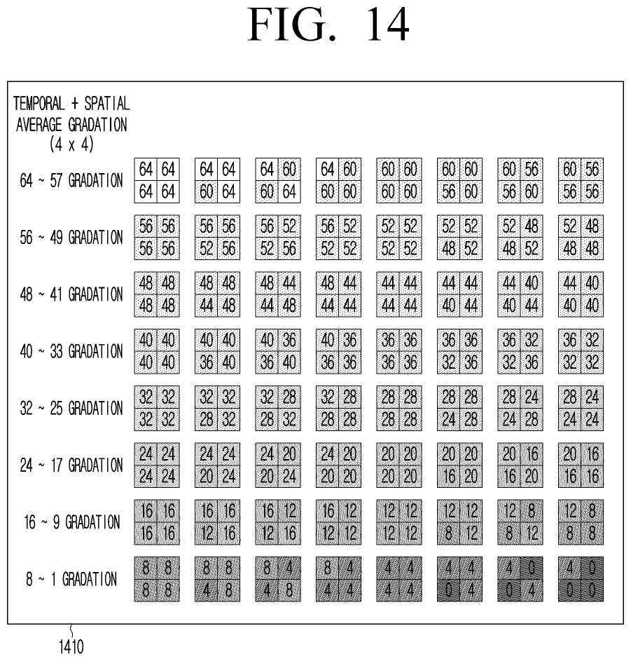

According to various embodiments, the mapping table may be implemented as illustratively shown in FIG. 7, FIG. 8, or FIG. 14.

Meanwhile, the at least one processor 130 may control the display 110 to display the first frame and, after a preset time elapses from the time when the first frame is displayed, control the display 110 to display the second frame.

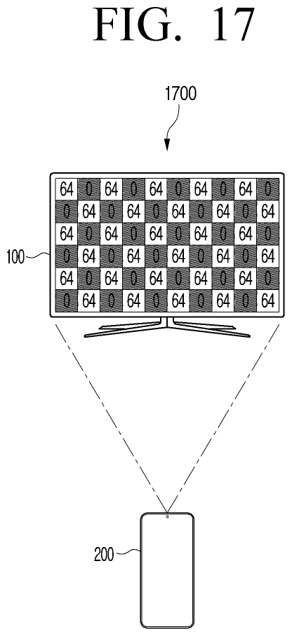

The first and second frames may be frames that are output in chronological order. There may be a preset time interval between when the first frame and the second frame are output. This is due to the need to accurately capture the sample image through the camera of an external device 200 (see, e.g., FIG. 17).

The external device 200 may be a device including a camera, and may be a device for inspecting the display 110 of the electronic device 100.

For example, when the first frame and the second frame are displayed consecutively in a short time, such as 0.01 seconds, the external device 200 may not be able to accurately capture the first frame and the second frame. Thus, the at least one processor 130 may output the second frame after a threshold time (1 second) from the time of outputting the first frame.

Meanwhile, when a user control command for correcting the gradation values is received, the at least one processor 130 may control the display 110 to display, in sequence, sample images corresponding to each of a plurality of gradation values that are above a preset first gradation value and below a preset second gradation value.

The user command for correcting the gradation values may be a command for generating a correction filter. The plurality of gradation values may display a sample image corresponding to each of gradation value 1 to gradation value 63. The at least one processor 130 may output a sample image for a target gradation value. A description regarding the target gradation value will be provided with reference to FIG. 18.

Meanwhile, the gradation value of the first frame may be an average gradation value of a plurality of pixels included in the first frame, and the gradation value of the second frame may be an average gradation value of a plurality of pixels included in the second frame.

The method of calculating the average gradation value for each frame will be described in FIGS. 3 to 14.

Meanwhile, the sample image may be an image in which the position of the first type pixel in the first frame and the position of the first type pixel in the second frame are different.

The first type pixel may refer to a pixel having gradation value 0. The first arrangement information indicating the position of gradation value 0 in the first frame may be different from the second arrangement information indicating the position of gradation value 0 in the second frame.

For example, in the first frame of the embodiment 520 of FIG. 5, the position of the gradation value 0 may be (1,1), (1,2), (2,1), and (2,2). The position of gradation value 0 in the second frame may not exist. The first arrangement information of the first frame may be different from the second arrangement information of the second frame.

For example, the position of gradation value 0 in the first frame of the embodiment 540 of FIG. 5 may be (1,1), (1,2), (2,1), and (2,2). The position of gradation value 0 in the second frame may be (1,2) and (2,1). The first arrangement information of the first frame may be different from the second arrangement information of the second frame.

The electronic device 100 may further include a communication interface 140 (including, e.g., communication interface circuitry) that performs communication with the external device 200, and the at least one processor 130 may receive a captured image including a sample image from the external device 200 through the communication interface 140, obtain a gradation value of a first pixel group arranged at a first position based on the sample image, obtain a gradation value of a second pixel group arranged at a second position based on the captured image, and correct a gradation setting value of the display 110 by comparing the gradation value obtained from the sample image with the gradation value obtained from the captured image.

Meanwhile, the at least one processor 130 may obtain a difference value between the gradation value of the first pixel group obtained from the captured image and the gradation value of the second pixel group obtained from the sample image, and when the difference value is equal to or greater than a threshold value, obtain a correction filter for changing the gradation value of the pixel group at the first position based on the difference value.

Meanwhile, when a user input for displaying the input image is received, the at least one processor 130 may correct the input image by changing a gradation value of a third pixel group arranged at the first position of the input image based on the correction filter, and control the display 110 to display the corrected input image.

The first pixel group may be a group of unit pixels representing the third gradation value (target gradation value). The first position may refer, for example, to a position (or an arrangement range) of a plurality of pixels.

The pixel group may be described as a pixel array, pixel information, pixel data, etc.

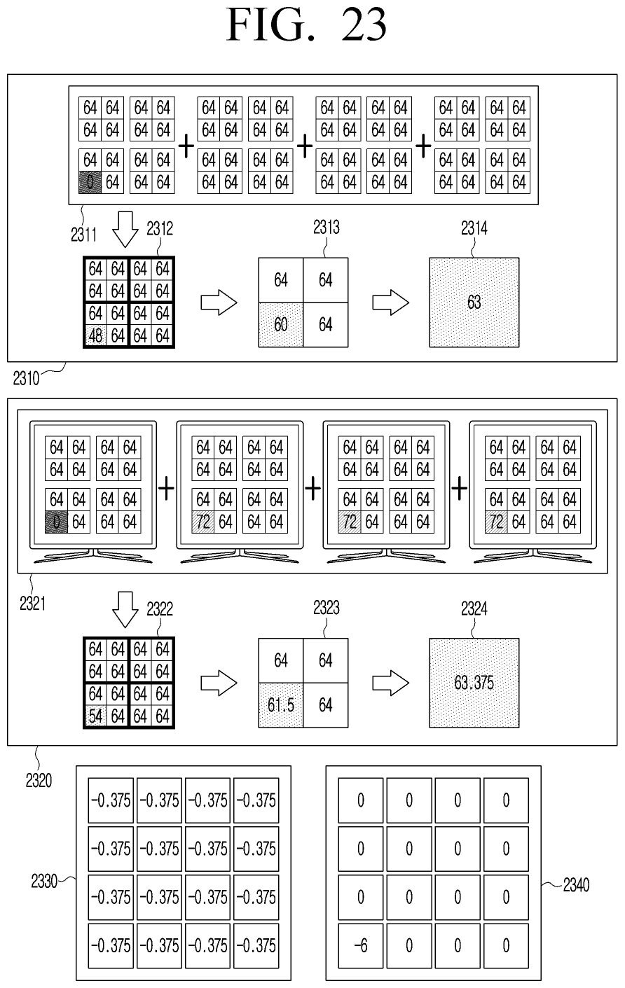

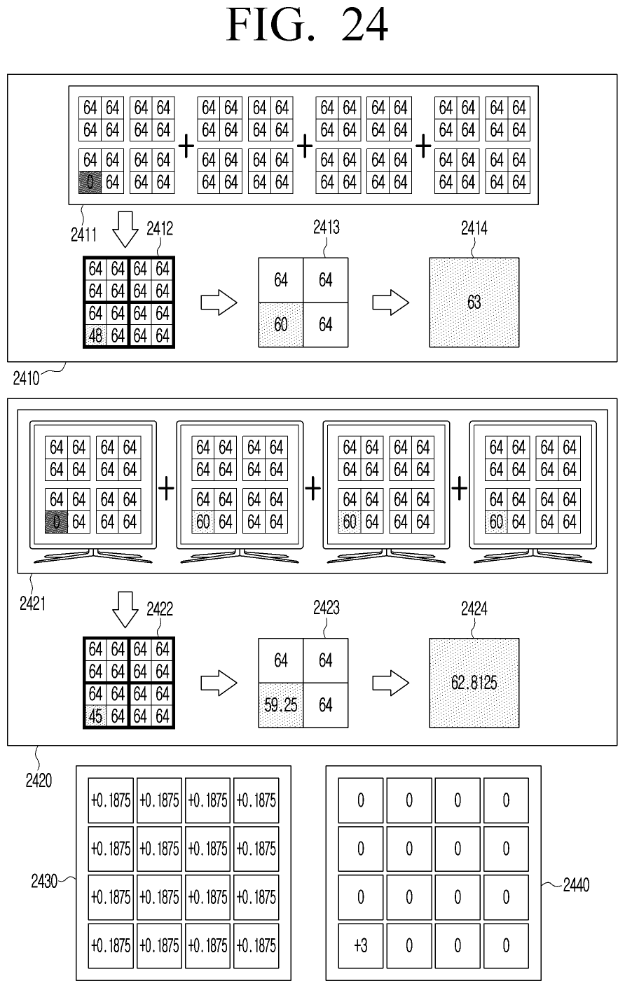

According to various embodiments, the at least one processor 130 may apply the correction filter to a pixel group including a plurality of pixel groups. A detailed description thereof will be provided with reference to a correction filter 2330 of FIG. 23 and a correction filter 2340 of FIG. 24.

According to various example embodiments, the at least one processor 130 may apply the correction filter only to a specific group in which a difference value is identified among a pixel group including a plurality of pixel groups. A detailed description thereof will be provided with reference to a correction filter 2340 of FIG. 23 and a correction filter 2440 of FIG. 24.

Meanwhile, the at least one processor 130 may apply the correction filter differently depending on the type of program running at the time when the input image is received.

When the correction filter 2430 is applied, the overall visibility may be improved, and the difference in gradation values between screens may not be significant. Accordingly, when an input image is received while a photo program (or photo application) is running, the at least one processor 130 may perform a correction operation using the correction filters 2330, 2430 applied to a pixel group.

When the correction filter 2440 is applied, an error corresponding to a specific pixel can be precisely corrected. Thus, when an input image is received while a task program (or task application) is running, the at least one processor 130 may perform a correction operation using the correction filters 2340, 2440 applied to a specific pixel.

Meanwhile, the at least one processor 130 may determine whether the input image includes text. Further, the at least one processor 130 may apply the correction filter differently depending on whether text is included.

When the input image does not include text, the at least one processor 130 may correct the input image using the correction filters 2330, 2430. This is because overall uniformity may be more important when text is not included.

When the input image includes text, the at least one processor 130 may correct the input image using correction filters 2340, 2440. This is because the accuracy of each pixel may be important when text is included.

The electronic device 100 according to various embodiments may output a sample image using a pixel group for gradation values 1 to 63 corresponding to low gradation. Thus, the inspection method of the electronic device 100 using the sample image may reduce errors occurring in the general inspection method (method of using gradation values 1 to 63 gradation values as they are). Furthermore, the correction accuracy of the input image may be high when using the correction filter generated in a state in which there are few errors.

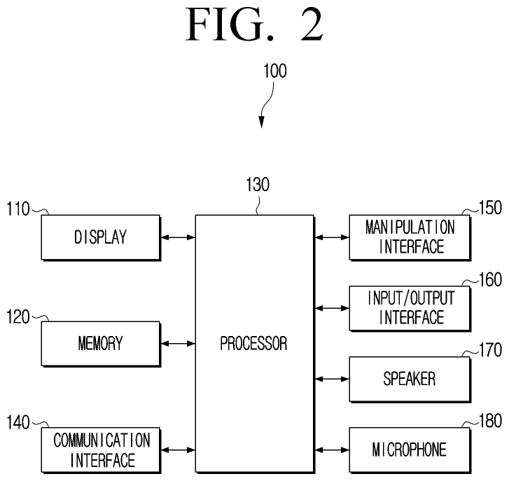

Meanwhile, in the above, only the simple configuration of the electronic device 100 is illustrated and described, but various additional configurations may be provided during implementation, which will be described below with reference to FIG. 2.

FIG. 2 is a block diagram illustrating a specific configuration of the example electronic device of FIG. 1.

Referring to FIG. 2, the electronic device 100 may include at least one of the display 110, the memory 120, the at least one processor 130, the communication interface 140, a manipulation interface 150, an input/output interface 160, a speaker 170, or a microphone 180. Overlapping descriptions regarding the same operations as previously described are not repeated.

The electronic device 100 according to various embodiments may include at least one of, for example, a smartphone, a tablet PC, a mobile phone, a desktop PC, a laptop PC, a PDA, a portable multimedia player (PMP), or the like. In various embodiments, the electronic device 100 may include at least one of, for example, a television, a digital video disk (DVD) player, a media box (e.g., Samsung HomeSync™ Apple TV™, or Google TV™), or the like.

The display 110 may be implemented as various types of displays such as a Liquid Crystal Display (LCD), an Organic Light Emitting Diodes (OLED) display, a Plasma Display Panel (PDP), and the like. The display 110 may also include a driving circuit, a backlight unit, and the like, which may be implemented in the form of amorphous silicon thin film transistor (a-si TFTs), low temperature poly silicon (LTPS) TFTs, organic TFTs (OTFTs), and the like. Meanwhile, the display 110 may be implemented as a touch screen combined with a touch sensor, a flexible display, a three-dimensional (3D) display, and the like. Further, the display 110 according to an embodiment may include not only a display panel that outputs an image but also a bezel that houses a display panel. In particular, a bezel according to an example embodiment may include a touch sensor (not shown) for detecting a user interaction.

The memory 120 may be implemented as internal memory such as ROM (e.g., electrically erasable programmable read-only memory (EEPROM)) or RAM, etc. included in the processor 130, or may be implemented as separate memory from the processor 130. In this case, the memory 120 may be implemented as memory embedded in the electronic device 100 or as memory that can be attached or detached to and from the electronic device 100 depending on the purpose of data storage. For example, in the case of data for driving the electronic device 100, the data may be stored in memory embedded in the electronic device 100, and in the case of data for the expansion function of the electronic device 100, the data may be stored in memory detachable from the electronic device 100.

Meanwhile, in a case of memory embedded in the electronic device 100, the memory may be implemented as at least one of a volatile memory (e.g. a dynamic RAM (DRAM), a static RAM (SRAM), or a synchronous dynamic RAM (SDRAM)) or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g. a NAND flash or a NOR flash), a hard drive, or a solid state drive (SSD)), and in a case of memory detachable from the electronic device 100, the memory may be implemented in the form of a memory card (e.g., a compact flash (CF), a secure digital (SD), a micro secure digital (Micro-SD), a mini secure digital (Mini-SD), an extreme digital (xD), or a multi-media card (MMC)), an external memory connectable to a USB port (e.g., a USB memory), or the like.

The at least one processor 130 (including, e.g., processing circuitry) may perform overall control operations of the electronic device 100. Specifically, the processor 130 functions to control the overall operation of the electronic device 100.

The processor 130 may be implemented as one or more of a digital signal processor (DSP) for processing digital signals, a microprocessor, or a Time Controller (TCON). However, the processor 130 is not limited thereto, and may include one or more of a central processing unit (CPU), a Micro Controller Unit (MCU), a micro processing unit (MPU), a controller, an application processor (AP), a graphics-processing unit (GPU) or a communication processor (CP), or an advanced RISC machine (ARM) processor, or may be defined by the corresponding term. Further, the processor 130 may be implemented as a system-on-chip (SoC) or a large scale integration (LSI) in which a processing algorithm is embedded, or may be implemented in the form of a field programmable gate array (FPGA). In addition, the processor 130 may perform various functions by executing computer executable instructions stored in the memory.

The communication interface 140 (including, e.g., communication interface circuitry) is configured to perform communication with various types of external devices according to various types of communication methods. The communication interface 140 may include a wireless communication module or a wired communication module. Here, each communication module may be implemented in the form of at least one hardware chip.

The wireless communication module may be a module that performs communication with an external device. For example, the wireless communication module may include at least one of a Wi-Fi module, a Bluetooth module, an infrared communication module, or other communication modules and circuits.

The Wi-Fi module and the Bluetooth module may perform communication using a Wi-Fi method and a Bluetooth method, respectively. When using a Wi-Fi module or a Bluetooth module, various connection information such as SSID and session keys are first transmitted and received, and various information can be transmitted and received after establishing communication connection using this.

The infrared communication module performs communication according to an infrared Data Association (IrDA) communication technology which transmits data wirelessly over a short distance using infrared rays between optical light and millimeter waves.

Other communication modules may include at least one communication chip that performs communication according to various wireless communication standards such as Zigbee, 3rd Generation (3G), 3rd Generation Partnership Project (3GPP), Long Term Evolution (LTE), LTE advanced (LTE-A), 4th Generation (4G), 5th Generation (5G), etc.

The wired communication module may be a module that performs communication with an external device via a cable. For example, the wired communication module may include at least one of a Local Area Network (LAN) module, an Ethernet module, a pair cable, a coaxial cable, an optical fiber cable, or a Ultra Wide-Band (UWB) module.

The manipulation interface 150 (including, e.g., manipulation interface circuitry) may be implemented as a button, a touch pad, a mouse, a keyboard, etc., or may be implemented as a touch screen that can also perform a display function and a manipulation input function. Here, the button may be a various types of buttons such as a mechanical button, a touch pad, a wheel, etc. formed in any arbitrary area such as front, side, back, etc.

The input/output interface 160 (including, e.g., input/output interface circuitry) may be one of High Definition Multimedia Interface (HDM), Mobile High-Definition Link (MHL), Universal Serial Bus (USB), Display Port (DP), Thunderbolt, Video Graphics Array (VGA) port, RGB port, D-subminiature (D-SUB), or Digital Visual Interface (DVI). The input/output interface 160 may input/output at least one of audio or video signals. Depending on an implementation example, the input/output interface 160 may include a port that inputs/outputs only audio signals and a port that inputs/outputs only video signals as separate ports, or may be implemented as a single port that inputs/outputs both audio and video signals. Meanwhile, the electronic device 100 may transmit at least one of an audio signal or a video signal to an external device (e.g., an external display device or an external speaker) through the input/output interface 160. Specifically, the output port included in the input/output interface 160 may be connected to an external device, and the electronic device 100 may transmit one of the audio signal or the video signal to the external device through the output port.

Here, the input/output interface 160 may be connected to the communication interface. The input/output interface 160 may transmit information received from the external device to the communication interface or may transmit information received through the communication interface to the external device.

The speaker 170 may be a component that outputs various audio data as well as various notification sounds or voice messages.

The microphone 180 is configured to receive a user voice or other sound and convert it into audio data. The microphone 180 may receive a user voice in an activated state. For example, the microphone 180 may be integrally formed in the direction of the top, front, side, etc. of the electronic device 100. The microphone 180 may include various configurations such as a microphone that collects a user voice in an analog form, an amplification circuit that amplifies the collected user voice, an A/D conversion circuit that samples the amplified user voice and converts it into a digital signal, a filter circuit that removes noise components from the converted digital signal, etc.

FIG. 3 is a view provided to explain spatial dithering according to various embodiments.

Referring to FIG. 3, the electronic device 100 may, for example, generate a pixel group of size 2*2. Here, the pixel group may include a plurality of pixels. The number written in each pixel may represent a gradation value.

Referring to example 310, a pixel group may include a pixel at coordinates [1,1] having gradation value 64, a pixel at coordinates [1,2] having gradation value 64, a pixel at coordinates [2,1] having gradation value 64, and a pixel at coordinates [2,2] having gradation value 64. The average of the gradation values of the plurality of pixels may be gradation value 64. The average gradation value of the pixel group may be 64.

Referring to example 320, a pixel group may include a pixel at coordinates [1,1] having gradation value 64, a pixel at coordinates [1,2] having gradation value 64, a pixel at coordinates [2,1] having gradation value 64, and a pixel at coordinates [2,2] having gradation value 0. The average of the gradation values of the plurality of pixels may be gradation value 48. The average gradation value of the pixel group may be 48.

Referring to example 330, a pixel group may include a pixel at coordinates [1,1] having gradation value 64, a pixel at coordinates [1,2] having gradation value 0, a pixel at coordinates [2,1] having gradation value 0, and a pixel at coordinates [2,2] coordinate having gradation value 64. The average of the gradation values of the plurality of pixels may be gradation value 32. The average gradation value of the pixel group may be 32.

Referring to example 340, a pixel group may include a pixel at coordinates [1,1] having gradation value 64, a pixel at coordinates [1,2] having gradation value 0, a pixel at coordinates [2,1] having gradation value 0, and a pixel at coordinates [2,2] having gradation value 0. The average of the gradation values of the plurality of pixels may be gradation value 16. The average gradation value of the pixel group may be 16.

Referring to example 350, a pixel group may include a pixel at coordinates [1,1] having gradation value 0, a pixel at coordinates [1,2] having gradation value 0, a pixel at coordinates [2,1] having gradation value 0, and a pixel at coordinates [2,2] having gradation value 0. The average of the gradation values of the plurality of pixels may be gradation value 0. The average gradation value of the pixel group may be 0.

As disclosed in FIG. 3, the average gradation value may vary depending on the arrangement of gradation values 64 in a pixel group including a plurality of pixels. The electronic device 100 may perform a dithering operation by taking into account the arrangement positions of the gradation values in the pixel group. The dithering operation that considers the arrangement positions of the gradation values may be described as a spatial dithering operation.

FIG. 4 is a view provided to explain spatial dithering according to various embodiments.

Referring to FIG. 4, even if the average gradation value of the pixel group is the same, there may be different pixel groups depending on the arrangement positions of the gradation values.

Referring to example 410, there may be only one pixel group having average gradation value 64. A pixel group of size 2*2 may have gradation value 64 arranged at all of coordinates [1,1], [1,2], [2,1], and [2,2].

Referring to example 420, there may be four pixel groups having average gradation value 48. A pixel having gradation value 0 may be arranged at one of coordinates [1,1], [1,2], [2,1], and [2,2]. In pixels other than the pixels having gradation value 0, gradation value 64 may be arranged. The average gradation value may be 48 regardless of which pixel group is used.

Referring to example 430, there may be six pixel groups having average gradation value 32. A pixel having gradation value 0 may be arranged at any two of coordinates [1,1], [1,2], [2,1], and [2,2]. Further, a pixel having gradation value 64 may be arranged at any two of coordinates [1,1], [1,2], [2,1], and [2,2]. The average gradation value may be 32 regardless of which pixel group is used.

Referring to example 440, there may be four pixel groups having average gradation value 16. A pixel having gradation value 64 may be arranged at one of coordinates [1,1], [1,2], [2,1], and [2,2]. In pixels other than the pixels having gradation value 64, gradation value 0 may be arranged. The average gradation value may be 16 regardless of which pixel group is used.

Referring to example 450, there may be only one pixel group having average gradation value 0. A pixel group of size 2*2 may have gradation value 0 arranged at coordinates [1,1], [1,2], [2,1], and [2,2].

The user may predetermine which pixel group among the plurality of pixel groups to use. The predetermined pixel group may be used to represent a specific gradation value.

FIG. 5 is a view provided to explain temporal dithering according to various embodiments.

Referring to FIG. 5, the dithering operation may output a plurality of frames at different times. The first frame may be output at a first time point, the second frame may be output at a second time point, the third frame may be output at a third time point, and the fourth frame may be output at a fourth time point. When the first frame to the fourth frame are output within a preset period, the user may recognize the entire image with the average gradation value of the first to fourth frames.

Referring to example 510, a pixel group having average gradation value 64 may include the first frame including the pixel group of [(64,64),(64,64)], the second frame including the pixel group of [(64,64),(64,64)], the third frame including the pixel group of [(64,64),(64,64)], and the fourth frame including the pixel group of [(64,64),(64,64)].

Referring to example 520, a pixel group having average gradation value 48 may include the first frame including the pixel group of [(0,0),(0,0)], the second frame including the pixel group of [(64,64),(64,64)], the third frame including the pixel group of [(64,64),(64,64)], and the fourth frame including the pixel group of [(64,64),(64,64)].

Referring to example 530, a pixel group having average gradation value 32 may include the first frame including the pixel group of [(0,0),(0,0)], the second frame including the pixel group of [(64,64),(64,64)], the third frame including the pixel group of [(0,0),(0,0)], and the fourth frame including the pixel group of [(64,64),(64,64)].

Referring to example 540, a pixel group having having average gradation value 16 may include the first frame including the pixel group of [(0,0),(0,0)], the second frame including the pixel group of [(64, 0),(0,64)], the third frame including the pixel group of [(0,0),(0,0)], and the fourth frame including the pixel group of [(64, 0),(0,64)].

Referring to example 550, a pixel group having average gradation value 0 may include the first frame including the pixel group of [(0,0),(0,0)], the second frame including the pixel group of [(0,0),(0,0)], the third frame including the pixel group of [(0,0),(0,0)], and the fourth frame including the pixel group of [(0,0),(0,0)].

The order of the frames may be changed according to various embodiments.

FIG. 6 is a view provided to explain temporal dithering according to various embodiments.

Referring to example 610 of FIG. 6, a pixel group having average gradation value 48 may be represented in four different ways according to the order of frames including the pixel group of [(0,0),(0,0)] or frames including the pixel group of [(64,64),(64,64)].

Referring to example 620 of FIG. 6, a pixel group having average gradation value 32 may be represented in six different ways according to the order of frames including the pixel group of [(0,0),(0,0)] or frames including the pixel group of [(64,64),(64,64)].

FIG. 7 is a view provided to explain spatial-temporal dithering according to various embodiments.

Referring to FIG. 7, the dithering operation may be performed by considering both spatial and temporal features. By combining the spatial dithering described in FIGS. 3 and 4 and the temporal dithering described in FIGS. 5 and 6, spatial-temporal dithering can be performed.

Referring to example 710, there may be a plurality of frames representing pixel groups representing average gradation values 64, 60, 56, 52, 48, 44, 40, 36, 32, and 28.

A pixel group having average gradation value of 64 may include the first frame including the pixel group of [(64,64),(64,64)], the second frame including the pixel group of [(64,64),(64,64)], the third frame including the pixel group of [(64,64),(64,64)], and the fourth frame including the pixel group of [(64,64),(64,64)].

A pixel group having average gradation value 60 may include the first frame including the pixel group of [(64,64),(0,64)], the second frame including the pixel group of [(64,64),(64,64)], the third frame including the pixel group of [(64,64),(64,64)], and the fourth frame including the pixel group of [(64,64),(64,64)].

A pixel group having average gradation value 56 may include the first frame including the pixel group of [(64,64),(0,64)], the second frame including the pixel group of [(64,64),(64,64)], the third frame including the pixel group of [(64,0),(64,64)], and the fourth frame including the pixel group of [(64,64),(64,64)].

A pixel group having average gradation value 52 may include the first frame including the pixel group of [(64,64),(0,64)], the second frame including the pixel group of [(64,64),(64,0)], the third frame including the pixel group of [(64,0),(64,64)], and the fourth frame including the pixel group of [(64,64),(64,64)].

A pixel group having average gradation value 48 may include the first frame including the pixel group of [(64,64),(0,64)], the second frame including the pixel group of [(64,64),(64,0)], the third frame including the pixel group of [(64,0),(64,64)], and the fourth frame including the pixel group of [(0,64),(64,64)].

A pixel group having average gradation value 44 may include the first frame including the pixel group of [(64,0),(0,64)], the second frame including the pixel group of [(64,64),(64,0)], the third frame including the pixel group of [(64,0),(64,64)], and the fourth frame including the pixel group of [(0,64),(64,64)].

Meanwhile, since frames for pixel groups having average gradation values of 40, 36, 32, 28, and the like are disclosed in FIG. 7, a similar description is not presented.

FIG. 8 is a view provided to explain spatial-temporal dithering according to various embodiments.

Referring to example 810 of FIG. 8, there may be a plurality of frames representing pixel groups representing average gradation values 24, 20, 16, 12, 8, 4, and 0.

Since frames for pixel groups having an average gradation value are disclosed in FIG. 7, a similar description is not repeated.

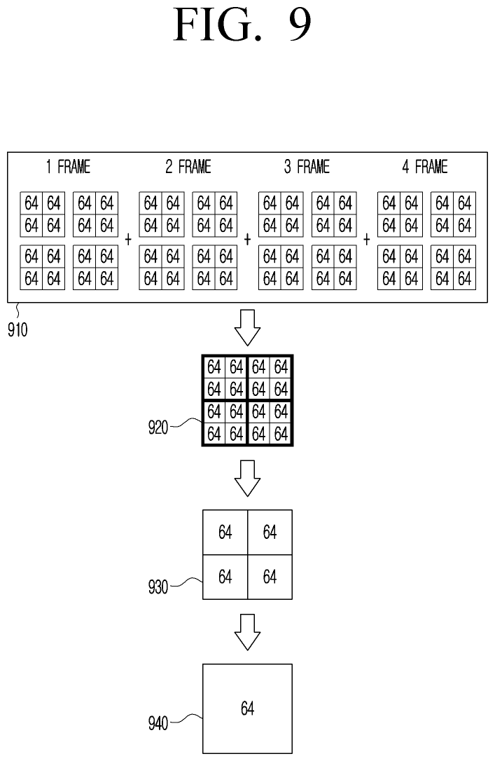

In FIGS. 9 to 13, the dithering operation may be performed using a pixel group of size 4*4. It is assumed that a pixel group of size 4*4 operates with four frames.

FIG. 9 is a view provided to explain an average gradation value according to various embodiments.

Referring to FIG. 9, a pixel group of size 4*4 with average gradation value 64 is described.

Example 910 represents the first frame of [{(64,64),(64,64)}, {(64,64),(64,64)}, {(64,64),(64,64)}, {(64,64),(64,64)}], the second frame of [{(64,64),(64,64)}, {(64,64),(64,64)}, {(64,64),(64,64)}, {(64,64),(64,64)}], the third frame of [{(64,64),(64,64)}, {(64,64),(64,64)}, {(64,64),(64,64)}, {(64,64),(64,64)}], and the fourth frame of [{(64,64),(64,64)}, {(64,64),(64,64)}, {(64,64),(64,64)}, {(64,64),(64,64)}]

Referring to example 920, pixel group 920 represents the average gradation value of the four frames of the example 910.

Referring to example 930, pixel group 930 represents the average gradation value of 2*2 size unit in the pixel group 920.

Referring to example 940, pixel group 940 represents the average gradation value of 4*4 size unit.

FIG. 10 is a view provided to explain an average gradation value according to various embodiments.

Referring to FIG. 10, a pixel group of size 4*4 with average gradation value 63 is described.

Example 1010 represents the first frame of [{(64,64),(64,64)}, {(64,64),(64,64)}, {(64,64),(0,64)}, {(64,64),(64,64)}], the second frame of [{(64,64),(64,64)}, {(64,64),(64,64)}, {(64,64),(64,64)}, {(64,64),(64,64)}], the third frame of [{(64,64),(64,64)}, {(64,64),(64,64)}, {(64,64),(64,64)}, {(64,64),(64,64)}], and the fourth frame of [{(64,64),(64,64)}, {(64,64),(64,64)}, {(64,64),(64,64)}{(64,64),(64,64)}].

Referring to example 1020, pixel group 1020 represents the average gradation value of the four frames of the example 1010.

Referring to example 1030, pixel group 1030 represents the average gradation value of 2*2 size unit in the pixel group 1020.

Referring to example 1040, pixel group 1040 represents the average gradation value of 4*4 size unit.

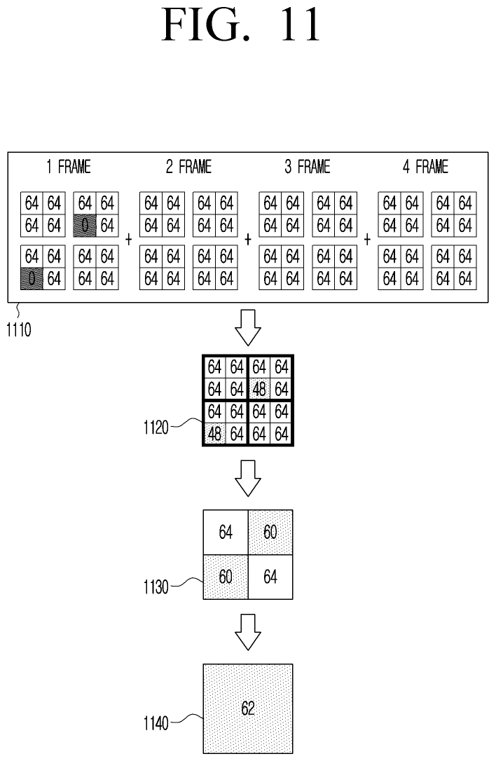

FIG. 11 is a view provided to explain an average gradation value according to various embodiments.

Referring to FIG. 11, a pixel group of size 4*4 with average gradation value 62 is described.

Example 1110 represents the first frame of [{(64,64),(64,64)}, {(64,64),(0,64)}, {(64,64),(0,64)}, {(64,64),(64,64)}], the second frame of [{(64,64),(64,64)}, {(64,64),(64,64)}, {(64,64),(64,64)}, {(64,64),(64,64)}], the third frame of [{(64,64),(64,64)}, {(64,64),(64,64)}, {(64,64),(64,64)}, {(64,64),(64,64)}], and the fourth frame of [{(64,64),(64,64)}, {(64,64),(64,64)}, {(64,64),(64,64)}, {(64,64),(64,64)}].

Referring to example 1120, pixel group 1120 represents the average gradation value of the four frames of the example 1110.

Referring to example 1130, pixel group 1130 represents the average gradation value of 2*2 size unit in the pixel group 1120.

Referring to example 1140, pixel group 1140 represents the average gradation value of 4*4 size unit.

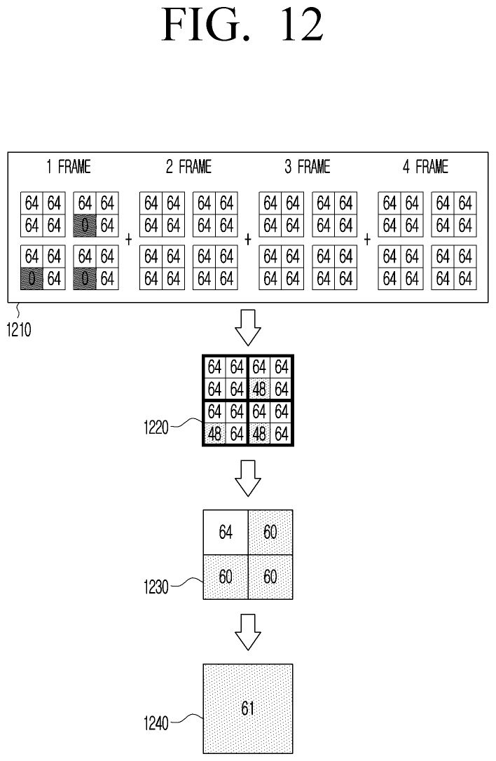

FIG. 12 is a view provided to explain an average gradation value according to various embodiments.

Referring to FIG. 12, a pixel group of size 4*4 with average gradation value 61 is described.

Example 1210 represents the first frame of [{(64,64),(64,64)}, {(64,64),(0,64)}, {(64,64),(0,64)}, {(64,64),(0,64)}], the second frame of [{(64,64),(64,64)}, {(64,64),(64,64)}, {(64,64),(64,64)}, {(64,64),(64,64)}], the third frame of [{(64,64),(64,64)}, {(64,64),(64,64)}, {(64,64),(64,64)}, {(64,64),(64,64)}] and the fourth frame of [{(64,64),(64,64)}, {(64,64),(64,64)}, {(64,64),(64,64)}, {(64,64),(64,64)}].

Referring to example 1220, pixel group 1220 represents the average gradation value of the four frames of the example 1210.

Referring to example 1230, pixel group 1230 represents the average gradation value of 2*2 size unit in the pixel group 1220.

Referring to example 1240, pixel group 1240 represents the average gradation value of 4*4 size unit.

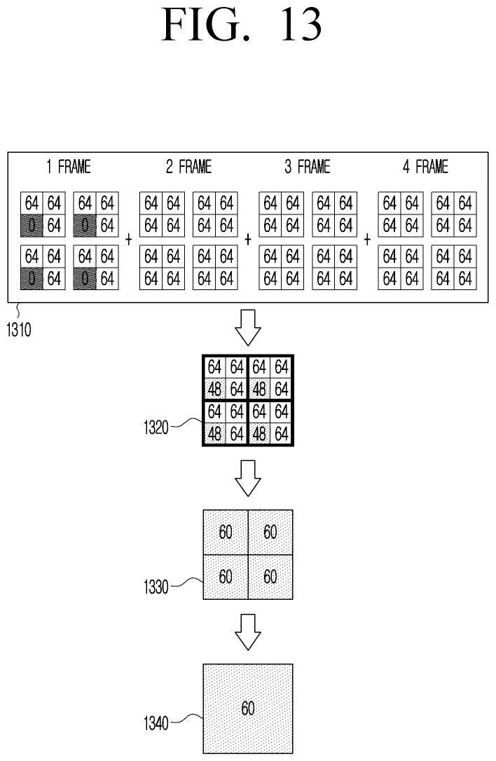

FIG. 13 is a view provided to explain an average gradation value according to various embodiments.

Referring to FIG. 13, a pixel group of size 4*4 with average gradation value 60 is described.

Example 1310 represents the first frame of [{(64,64),(0,64)}, {(64,64),(0,64)}, {(64,64),(0,64)}, {(64,64),(0,64)}], the second frame of [{(64,64),(64,64)}, {(64,64),(64,64)}, {(64,64),(64,64)}, {(64,64),(64,64)}], the third frame of [{(64,64),(64,64)}, {(64,64),(64,64)}, {(64,64),(64,64)}, {(64,64),(64,64)}], and the fourth frame of [{(64,64),(64,64)}, {(64,64),(64,64)}, {(64,64),(64,64)}, {(64,64),(64,64)}].

Referring to example 1320, pixel group 1320 represents the average gradation value of the four frames of the example 1310.

Referring to example 1330, pixel group 1330 represents the average gradation value of 2*2 size unit in the pixel group 1320.

Referring to example 1340, pixel group 1340 represents the average gradation value of 4*4 size unit.

FIGS. 9 to 13 illustrate pixel groups of size 4*4 with average gradation values of 64, 63, 62, 61, and 60. Similarly, there may be pixel groups of size 4*4 with average gradation values between 59 and 1.

FIG. 14 is a view provided to explain a sample image corresponding to a gradation value.

Referring to example 1410 of FIG. 14, there may be pixel groups of size 4*4 representing each of gradation values 1 to 64. For convenience of explanation, each pixel group in FIG. 14 represents the average gradation value of 2*2 size unit.

For example, each pixel group in FIG. 14 may be at the same level as the pixel group 930 of FIG. 9, the pixel group 1030 of FIG. 10, the pixel group 1130 of FIG. 11, the pixel group 1230 of FIG. 12, and the pixel group 1330 of FIG. 13.

The pixel groups disclosed in FIG. 14 are described as being of size 2*2, but each pixel may represent a pixel group of size 2*2. Thus, the pixel groups disclosed in FIG. 14 may be pixel groups of size 4*4.

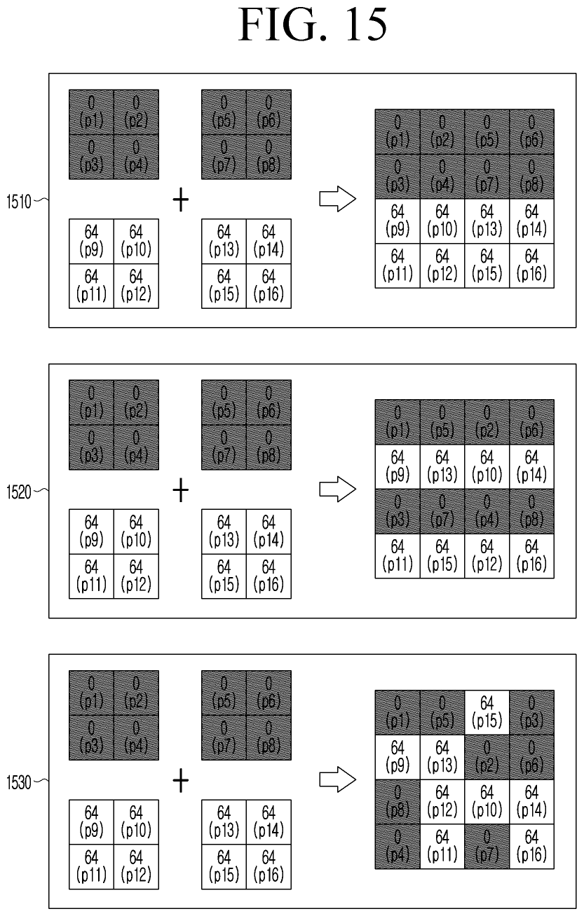

FIG. 15 is a view provided to explain an operation of generating a pixel group of size 4*4 using a pixel group of size 2*2.

Referring to FIG. 15, the dithering operation may generate a pixel group of size 4*4 by combining four pixel groups of size 2*2. There may be various ways to combine the four pixel groups.

Referring to example 1510, four groups of size 2*2 may be combined in sequence. A group of pixels of size 4*4 may be generated without changing the arrangement of a plurality of pixels included in a pixel group of size 2*2.

Referring to example 1520, a plurality of pixel groups included in each pixel group of size 2*2 may be rearranged according to a preset rule (or method). A pixel group of size 4*4 may be generated by rearranging a plurality of pixels in a pixel group of size 2*2 according to the preset rule. The preset rule may vary depending on the user's settings.

Referring to example 1530, the plurality of pixel groups included in each pixel group of size 2*2 may be randomly rearranged. By randomly rearranging the positions of the plurality of pixels in the pixel group of size 2*2, a pixel group of size 4*4 may be generated.

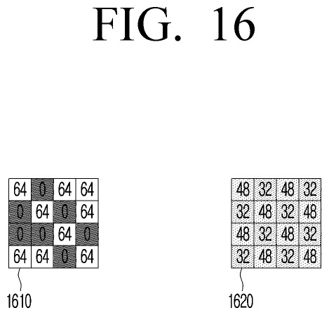

FIG. 16 is a view provided to explain a difference in perception of dither noise.

Pixel group 1610 in FIG. 16 may include a plurality of frames having the same arrangement information. Accordingly, the average gradation value of each pixel may be 64 or 0.

Pixel group 1620 of FIG. 16 may include a plurality of frames having different arrangement information. Accordingly, the average gradation value of each group may be 48 or 32.

The arrangement information may indicate the arrangement of gradation value 64 and the arrangement of gradation value 0. Each of the plurality of frames included in the pixel group 1610 may have the same arrangement gradation value 64 and the same arrangement gradation value 0. Each of the plurality of frames included in the pixel group 1620 may have some difference in the arrangement gradation value 64 and the arrangement of gradation value 0.

The pixel group 1610 may have a gradation difference between pixels of 64, and the pixel group 1620 may have a gradation difference between pixels of 16. Thus, the pixel group 1620 may be less visible for dither noise.

FIG. 17 is a view provided to explain an example system 1700 including an electronic device and an external device.

The system 1700 may include at least one of the electronic device 100 or the external device 200.

The electronic device 100 may test the gradation value output performance of a display included in the electronic device 100. Even if a plurality of display elements included in the display are the same, some errors may occur in the manufacturing process, etc. If errors occur in some of the display elements, the gradation value output performance may be different. Thus, the electronic device 100 may test the plurality of display elements included in the display to address this. The electronic device 100 may output a sample image through the display.

The external device 200 may photograph the electronic device 100. The external device 200 may obtain a captured image including the electronic device 100. The captured image may include a sample image displayed by the electronic device 100.

The sample image included in the captured image may actually represent the result of the gradation value output of the display. Thus, the captured image may be used to analyze the gradation output performance of the display

FIG. 18 is a flowchart illustrating an example operation of generating a correction filter.

Referring to FIG. 18, the electronic device 100 may receive a command for generating a correction filter (S1805). The correction filter may be a filter for changing the gradation value of an input image.

When the correction filter generation command is received, the electronic device 100 may output a sample image for testing at least one gradation value. One gradation value to be tested among the at least one gradation value may be described as a target gradation value.

For example, when two gradation values are tested, the electronic device 100 may set one of the two gradation values as the target gradation value and first display a sample image corresponding to the target gradation value. Subsequently, the electronic device 100 may set the remaining gradation value as the target gradation value and display a sample image corresponding to the target gradation value.

When the correction filter generation command is received, the electronic device 100 may determine whether the electronic device 100 outputs a target gradation value that is above the first gradation value and below the second gradation value (S1810).

When the target gradation value to be tested is above the first gradation value and is equal to or greater than the second gradation value (S1810-Y), the electronic device 100 may display a sample image corresponding to the target gradation value (S1815).

When the target gradation value to be tested is not above the first gradation value and below the second gradation value (S1810-N), the electronic device 100 may display a general image including only the target gradation value. For example, the first gradation value may refer to gradation value 0 and the second gradation value may refer to gradation value 64.

The general image may be an image in which all pixels constituting the image have the same gradation value (target gradation value). For example, when gradation value 65 is tested, the electronic device 100 may display a general image in which all pixels have gradation value 65.

The sample image may be an image in which the pixels constituting the image are composed of only the first and second gradation values to represent the target gradation value. For example, when gradation value 63 is tested, the electronic device 100 may generate a sample image including the first frame of [{(64,64),(64,64)}, {(64,64),(64,64)}, {(64,64),(0,64)}, {(64,64),(64,64)}], the second frame of [{(64,64),(64,64)}, {(64,64),(64,64)}, {(64,64),(64,64)}, {(64,64),(64,64)}], the third frame of [{(64,64),(64,64)}, {(64,64),(64,64)}, {(64,64),(64,64)}, {(64,64),(64,64)}], and the fourth frame of [{(64,64),(64,64)}, {(64,64),(64,64)}, {(64,64),(64,64)}, {(64,64),(64,64)}] as in the example 1010 of FIG. 10.

After the general image or the sample image are output, the electronic device 100 may obtain a captured image including the displayed image (S1825).

The electronic device 100 may determine whether all the gradation values for the test have been output (S1830). If all the gradation values are not output (S1830-N), the electronic device 100 may repeat steps S1810 to S1830.

When all the gradation values are output (S1830-Y), the electronic device 100 may may generate a correction filter by comparing the sample image and the captured image (S1835). The specific operation of generating the correction filter will be described with reference to FIGS. 23 and 24.

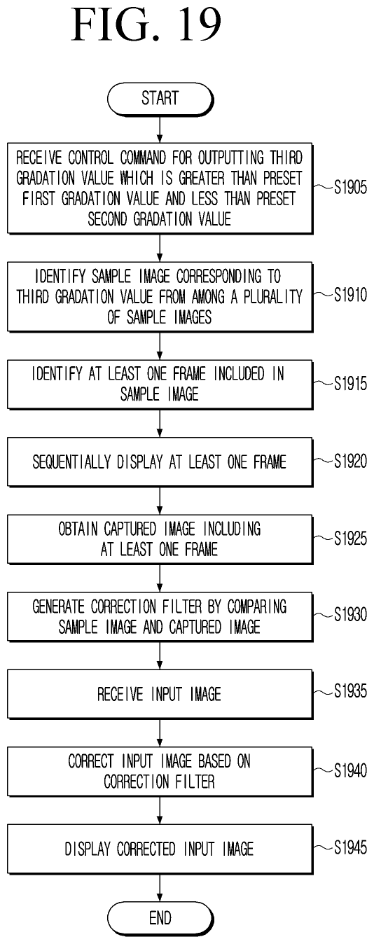

FIG. 19 is a flowchart illustrating an example operation of displaying a corrected input image.

Referring to FIG. 19, the electronic device 100 may receive a control command for outputting the third gradation value that is above a preset first gradation value and below a preset second gradation value (S1905). The control command may be a command for outputting a sample image for testing the target gradation value.

The electronic device 100 may identify a sample image corresponding to the third gradation value (target gradation value) among a plurality of sample images (S1910). The electronic device 100 may identify at least one frame included in the sample image (S1915). The electronic device 100 may display the at least one frame in sequence (S1920).

The electronic device 100 may obtain a captured image including at least one frame (S1925). The captured image may be an image in which a sample image displayed through the display of the electronic device 100 is captured.

The electronic device 100 may generate a correction filter by comparing the sample image and the captured image (S1930). The operation of generating the correction filter will be described with reference to FIGS. 23 and 24.

The electronic device 100 may correct a received input image (S1935) based on the correction filter (S1940), and the electronic device 100 may display the corrected input image (S1945).

For example, it is assumed that the gradation value of the pixel corresponding to the first position of the input image is 10 and the correction filter is a filter that changes the gradation value of the pixel corresponding to the first position by +3. The electronic device 100 may correct (or change) the gradation value of the pixel corresponding to the first position of the input image to 13. Subsequently, the electronic device 100 may display the corrected input image.

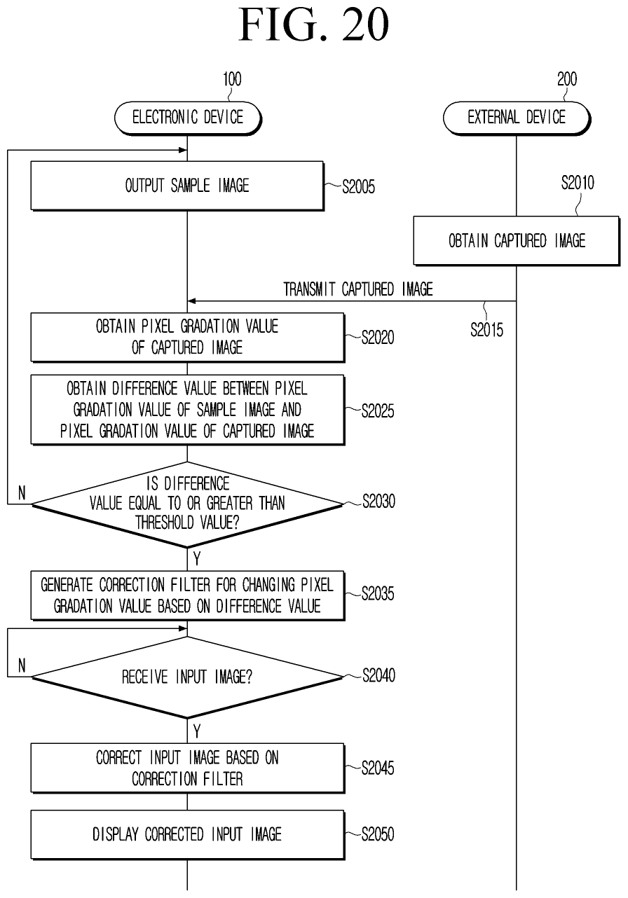

FIG. 20 is a flowchart illustrating an example operation of an electronic device generating a correction filter according to various embodiments.

Referring to FIG. 20, the electronic device 100 may output a sample image (S2005). The electronic device 100 may output a sample image corresponding to the target gradation value according to the correction filter generation command.

The external device 200 may obtain a captured image including a sample image (S2010). The external device 200 may transmit the captured image to the electronic device 100 (S2015).

The electronic device 100 may receive the captured image from the external device 200. The electronic device 100 may obtain a pixel gradation value of the captured image (S2020). The electronic device 100 may obtain a difference value between the pixel gradation value of the sample image and the pixel gradation value of the captured image (S2025). The pixel gradation value of the sample image may already be stored in the electronic device 100. The electronic device 100 may determine whether the difference value is above a threshold value (S2030).

When the difference value is not above the threshold value (S2030-N), the electronic device 100 may repeat steps S2005 and S2030.

When the difference value is above the threshold value (S2030-Y), the electronic device 100 may generate a correction filter for changing the pixel gradation value based on the difference value (S2035).

After generating the correction filter, the electronic device 100 may determine whether the input image is received (S2040). When the input image is received (S2040-Y), the electronic device 100 may correct the input image based on the correction filter (S2045). The electronic device 100 may display the corrected input image (S2050). The corrected input image may be described as a corrected image.

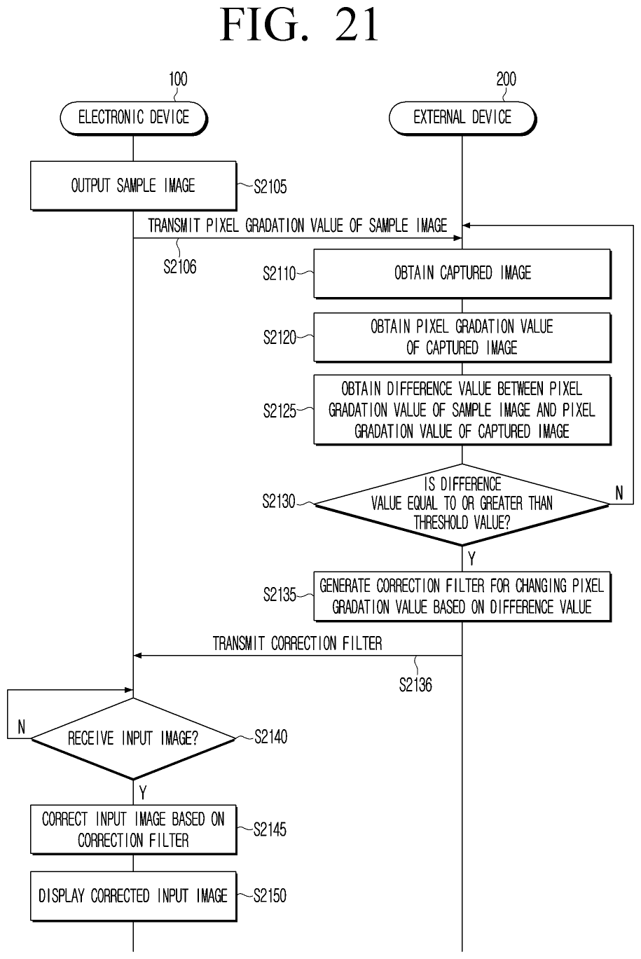

FIG. 21 is a flowchart illustrating an example operation of an external device generating a correction filter according to various embodiments.

Steps S2105, S2110, S2120, S2125, S2130, S2135, S2140, S2145, and S2150 of FIG. 21 may correspond to steps S2005, S2010, S2020, S2025, S2030, S2035, S2040, S2045, and S2050 of FIG. 20. Thus, redundant descriptions are not repeated. However, steps S2110, S2120, S2125, S2130, and S2135 may be performed in the external device 200, unlike in FIG. 20.

After outputting the sample image, the electronic device 100 may transmit the pixel gradation values of the sample image to the external device 200 (S2106). The pixel gradation value of the sample image may already be stored in the electronic device 100.

The external device 200 may receive the pixel gradation values of the sample image from the electronic device 100. Subsequently, the external device 200 may perform steps S2110 to S2135. After generating the correction filter, the external device 200 may transmit the correction filter to the electronic device 100 (S2136).

The electronic device 100 may receive the correction filter from the external device 200. Subsequently, the electronic device 100 may perform steps S2140 to S2150.

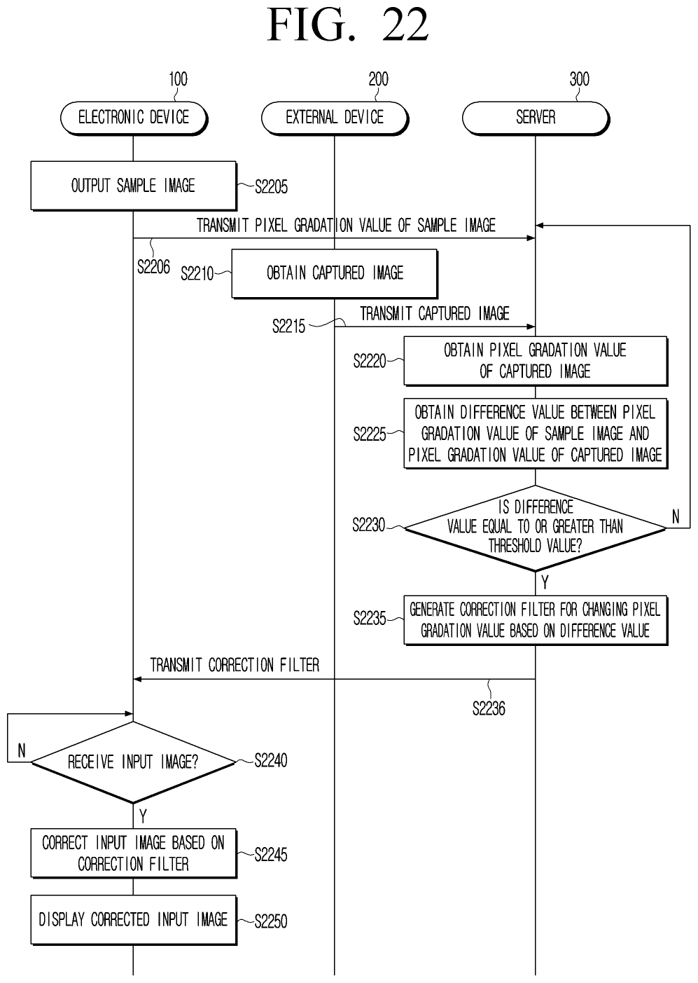

FIG. 22 is a flowchart illustrating an example operation of a server generating a correction filter according to various embodiments.

Steps S2205, S2206, S2210, S2220, S2225, S2230, S2235, S2236, S2240, S2245, and S2250 of FIG. 22 may correspond to steps S2105, S2106, S2110, S2120, S2125, S2130, S2135, S2136, S2140, S2145, and S2150 of FIG. 21. Thus, redundant descriptions are not repeated. However, steps S2220, S2225, S2230, S2235, and S2236 may be performed in the server 300.

The electronic device 100 may transmit the pixel gradation value of the sample image to the server 300 (S2206). Further, the external device 200 may transmit the captured image to the server 300 (S2215).

The server 300 may receive pixel gradation value of the sample image from the electronic device 100. The server 300 may receive the captured image from the external device 200. Subsequently, the server 300 may perform steps S2220 to S2235. The server 300 may transmit the correction filter to the electronic device 100 (S2236).

The electronic device 100 may receive the correction filter from the server 300. Subsequently, the electronic device 100 may perform steps S2240 to S2250.

FIG. 23 is a view provided to explain an example operation of comparing a sample image and a captured image according to various embodiments.

Referring to FIG. 23, the electronic device 100 may output a sample image through a display including a plurality of display elements. By outputting the sample image, the electronic device 100 may examine (or test) the gradation output performance of the display elements. It is assumed that there is a problem with the gradation value output performance of a particular display element. For example, it is assumed that when the display elements have a 4*4 array structure, there is an error in which the display element at position (4,1) outputs a value that is 8 greater than the existing gradation value. This error may be a hardware problem that occurs during the manufacturing process.

Sample image 2311, pixel group 2312, pixel group 2313, and pixel group 2314 of example 2310 may correspond to sample image 1011, pixel group 1012, pixel group 1013, and pixel group 1014 of FIG. 10. Accordingly, redundant descriptions are not repeated.

Captured image 2321 may include a sample image displayed by the electronic device 100. When it is assumed that there is an error in the display element at position (4,1) that outputs a value that is 8 larger than the existing gradation value, the captured image 2321 may include a sample image output by the display element that has the error. The gradation value at position (4,1) of the second to fourth frames may be 72.

Pixel group 2322 may be information that represents the average gradation value for each pixel by converting the captured image 2321 including four frames into one frame of size 4*4. The pixel group 2322 represents the average gradation value of the four frames of the captured image 2321.

Pixel group 2323 represents the average gradation value of 2*2 size unit in the pixel group 2322.

Pixel group 2324 represents the average gradation value of 4*4 size unit in the pixel group 2323.

The electronic device 100 may analyze the captured image 2321 as having the average gradation value of 63.375 corresponding to the captured image.

The electronic device 100 may obtain a difference value −0.375 between the average gradation value 63 of the sample image 2311 and the average gradation value 63.375 of the captured image 2321. The electronic device 100 may generate a correction filter 2330 based on the difference value −0.375. Since a pixel array of size 4*4 is used to represent gradation 63, the correction filter may also be generated in size 4*4.

When an input image is received, the electronic device 100 may apply the correction filter 2330 to correct the input image.

According to various example embodiments, the electronic device 100 may apply the correction filter 2330 to all input images received regardless of the gradation values of the input images.

According to various example embodiments, the electronic device 100 may use the correction filter 2330 generated by gradation value 63 only when outputting gradation value 63. The electronic device 100 may determine whether to apply the correction filter 2330 by considering the gradation value of the input image. It is assumed that the correction filter 2330 is a filter applied to the display element corresponding to the first position. When the gradation value to be output to the display element corresponding to the first position among a plurality of gradation values included in the input image is 63, the electronic device 100 may apply the correction filter 2330.

Meanwhile, for convenience of explanation, the sample image and the captured image are both described as having a size of 4*4, but depending on the number of display elements of the actual display, the sample image and the captured image may include a plurality of pixel groups of size 4*4.

The correction filter 2330 may be a filter that applies the same difference value to all pixels included in the pixel groups based on the calculated difference value −0.375.

According to various embodiments, the electronic device 100 may apply the difference value only to a specific pixel. The electronic device 100 may obtain a difference value −6 between gradation value 48 of the first pixel of the first position (4, 1) of the pixel group 2312 for the sample image and gradation value 54 of the second pixel of the first position (4, 1) of the pixel group 2322 for the captured image. The electronic device 100 may generate a correction filter 2340 based on the difference value −6. Unlike the correction filter 2330, the correction filter 2340 may perform a correction operation only for the specific pixel.

When the correction filter 2330 is applied, the overall visibility may be improved, and the difference in gradation values between screens may not be significant. Accordingly, when an input image is received while a photo program (or photo application) is running, the electronic device 100 may perform a correction operation by generating the correction filter 2330.

In addition, when the input image does not include text, the electronic device 100 may correct the input image using the correction filter 2330. This is because overall uniformity may be more important when text is not included.

When applying the correction filter 2340, an error corresponding to a specific pixel can be accurately corrected. Thus, when an input image is received while a task program (or task application) is running, the electronic device 100 may generate the correction filter 2340 and perform a correction operation.

Further, when the input image includes text, the electronic device 100 may correct the input image using the correction filter 2340. This is because the accuracy of each pixel may be important when text is included.

FIG. 24 is a view provided to explain an example operation of comparing a sample image and a captured image according to various embodiments.

Referring to FIG. 24, the electronic device 100 may output a sample image through a display including a plurality of display elements. By outputting the sample image, the electronic device 100 may examine (or test) the gradation output performance of the display elements. It is assumed that there is a problem with the gradation value output performance of a particular display element. For example, it is assumed that when the display elements have a 4*4 array structure, there is an error in which the display element at position (4,1) outputs a value (−8) that is 8 smaller than the existing gradation value. Such an error may be a hardware problem that occurs during the manufacturing process.

Example 2410 may represent an average gradation value of a sample image.

Sample image 2411, pixel group 2412, pixel group 2413, and pixel group 2414 of example 2410 may correspond to the sample image 1011, the pixel group 1012, the pixel group 1013, and the pixel group 1014 of FIG. 10. Accordingly, redundant descriptions are not repeated.

Captured image 2421 may include a sample image displayed by the electronic device 100. When it is assumed that there is an error in the display element at position (4,1) that outputs a value that is 8 smaller than the existing gradation value, the captured image 2421 may include a sample image output by the display element that has the error. The gradation value at position (4,1) of the second to fourth frames may be 60. The reason why the gradation value at position (4,1) of the second to fourth frames is 60 rather than 56 is that there may be an error in capturing low gradation. It is assumed that when a pixel with a gradation value of less than 64 is captured, the captured image does not clearly determine the low gradation. Thus, even though the display element is absolutely outputting the gradation value with an error of −8, the gradation value at the position (4,1) obtained through the captured image may be 60.

Pixel group 2422 may be information representing the average gradation value per pixel by converting the captured image 2421 including four frames into one frame of size 4*4. The pixel group 2422 represents the average gradation value of the four frames of the captured image 2421.

Pixel group 2424 represents the average gradation value of 2*2 size unit in the pixel group 2422.

Pixel group 2424 represents the average gradation value in 4*4 size unit in the pixel group 2424.

The electronic device 100 may analyze the captured image 2421 as having the average gradation value of 62.8125 corresponding to the captured image.

The electronic device 100 may obtain a difference value +0.1875 between the average gradation value 63 of the sample image 2411 and the average gradation value 62.8125 of the captured image 2421. The electronic device 100 may generate a correction filter 2430 based on the difference value+0.1875. Since a pixel array of size 4*4 is used to represent gradation 63, the correction filter may also be generated in size 4*4.

When an input image is received, the electronic device 100 may apply the correction filter 2430 to correct the input image.

According to various embodiments, the electronic device 100 may apply the difference value only to a specific pixel. The electronic device 100 may obtain a difference value +3 between gradation value 48 of the first pixel of the first position (4, 1) of the pixel group 2412 for the sample image and gradation value 45 of the second pixel of the first position (4, 1) of the pixel group 2422 for the captured image. The electronic device 100 may generate a correction filter 2440 based on the difference value +3. Unlike the correction filter 2430, the correction filter 2440 may perform a correction operation only for the specific filter.

When the correction filter 2430 is applied, the overall visibility may be improved, and the difference in gradation values between screens may not be significant. Accordingly, when an input image is received while a photo program (or photo application) is running, the electronic device 100 may perform a correction operation by generating the correction filter 2430.

In addition, when the input image does not include text, the electronic device 100 may correct the input image using the correction filter 2430. This is because overall uniformity may be more important when text is not included.

When applying the correction filter 2440, an error corresponding to a specific pixel can be accurately corrected. Thus, when an input image is received while a task program (or task application) is running, the electronic device 100 may generate the correction filter 2440 and perform a correction operation.

Further, when the input image includes text, the electronic device 100 may correct the input image using the correction filter 2440. This is because the accuracy of each pixel may be important when text is included.

Meanwhile, the description provided in FIG. 23 may be provided in FIG. 24.

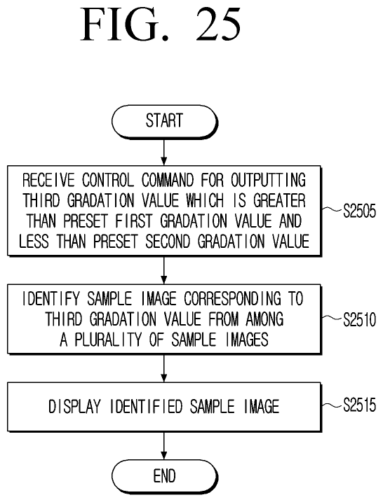

FIG. 25 is a flowchart illustrating an example controlling method of an electronic device according to various embodiments.

Referring to FIG. 25, a controlling method of an electronic device that stores a plurality of sample images includes a step (S2505) of receiving a control command for outputting a third gradation value that is above a preset first gradation value and below a preset second gradation value, a step (S2510) of identifying a sample image corresponding to the third gradation value among the plurality of sample images, and a step (S2515) of displaying the identified sample image, and the sample image includes a first frame including a plurality of pixels arranged based on first arrangement information and a second frame including a plurality of pixels arranged based on second arrangement information, the first arrangement information and the second arrangement information include a position of a first type pixel corresponding to the first gradation value or a position of a second type pixel corresponding to the second gradation value, and the third gradation value is an average value of the gradation value of the first frame and the gradation value of the second frame.

Meanwhile, the first gradation value may be a minimum gradation value that can be output through a display of the electronic device, and the second gradation value may be a minimum gradation value that can be corrected through a camera that captures a sample image.

Meanwhile, the electronic device may a mapping table indicating a sample image corresponding to each of the plurality of gradation values, and the step (S2510) of identifying a sample image may include, when a control command for outputting the third gradation value is received, identifying a sample image corresponding to the third gradation value based on the mapping table.

Meanwhile, the step (S2515) of displaying the sample image may include, when a preset time elapses from the time when the first frame is displayed, displaying the second frame.

Meanwhile, the example controlling method may further include, when a user control command for correcting a gradation value is received, sequentially displaying a sample image corresponding to each of a plurality of gradation values that are above a preset first gradation value and below a preset second gradation value.

Meanwhile, the gradation value of the first frame may be the average gradation value of the plurality of pixels included in the first frame, and the gradation value of the second frame may be the average gradation value of the plurality of pixels included in the second frame.

The sample image may be an image in which the position of the first type pixel in the first frame and the position of the first type pixel in the second frame are different.

Meanwhile, the example controlling method may further include receiving a captured image including a sample image from an external device, obtaining a gradation value of a first pixel group arranged at a first position based on the sample image, obtaining a gradation value of a second pixel group arranged at a second position based on the captured image, and correcting a gradation setting value of a display of the electronic device by comparing the gradation value obtained from the sample image with the gradation value obtained from the captured image.

Meanwhile, the example controlling method may further include obtaining a difference value between the gradation value of the first pixel group obtained from the captured image and the gradation value of the second pixel group obtained from the sample image, and, when the difference value is above a threshold value, obtaining a correction filter for changing the gradation value of the pixel group at the first position based on the difference value.

Meanwhile, the example controlling method may further include, when a user input for displaying the input image is received, correcting the input image by changing the gradation value of a third pixel group arranged at a first position of the input image based on the correction filter, and displaying the corrected input image.

Meanwhile, the example controlling method of the electronic device as in FIG. 25 may be executed in an electronic device having the configuration of FIG. 1 or FIG. 2, and may also be executed in an electronic device having other configurations.

Meanwhile, example methods according to various embodiments of the present disclosure described above may be implemented in the form of an application that can be installed in existing electronic devices.

In addition, methods according to various embodiments of the present disclosure described above may be implemented by software upgrades to existing electronic devices, or by hardware upgrades alone.

It is also possible for the various embodiments of the present disclosure described above to be performed via an embedded server provided in the electronic device or an external server of at least one of the electronic device or a display device.

Meanwhile, the above-described various embodiments may be implemented in software including one or more instructions stored in one or more machine-readable storage media that can be read by a machine (e.g., a computer). A machine may be a device that invokes the stored instructions from the storage medium and be operated based on the invoked instructions, and may include an electronic device according to various embodiments. In a case that the instructions are executed by the processor, the processor may directly perform a function corresponding to the instruction or other components may perform the function corresponding to the instruction under the control of the processor. The instruction may include codes generated or executed by a compiler or an interpreter. The machine-readable storage medium may be provided in the form of a non-transitory storage medium. Here, the term ‘non-transitory’ indicates that the storage medium is tangible without including a signal, and does not distinguish whether data are semi-permanently or temporarily stored in the storage medium.

Further, example methods according to various embodiments described above may be provided in a computer program product. The computer program product is a commodity and may be traded between a seller and a buyer. The computer program product may be distributed in the form of a device-readable storage medium (e.g., compact disc read only memory (CD-ROM)) or online through an application store (e.g., PlayStore™). In the case of online distribution, at least a portion of the computer program product may be at least temporarily stored or temporarily generated in a storage medium such as a server of a manufacturer, a server of an application store, or memory of a relay server.

Further, each of the components (e.g., modules or programs) according to the various embodiments described above may include a singular or plural number of entities, and some of the corresponding subcomponents described above may be omitted, or other subcomponents may be further included in the various embodiments. Alternatively or additionally, some components (e.g., modules or programs) may be integrated into a single entity that performs the same or similar functions as were performed by each of the respective components prior to the integration. In accordance with various embodiments, the operations performed by modules, programs, or other components may be executed sequentially, in parallel, iteratively, or heuristically, or at least some of the operations may be executed in a different order, omitted, or other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a display;
memory storing a plurality of sample images; and
at least one processor configured to:
receive a control command for outputting a third gradation value which is greater than a preset first gradation value and less than a preset second gradation value;
identify a sample image corresponding to the third gradation value from among the plurality of sample images; and
control the display to display the identified sample image,
wherein the sample image includes a first frame including a plurality of pixels arranged based on first arrangement information and a second frame including a plurality of pixels arranged based on second arrangement information;
wherein the first arrangement information and the second arrangement information include a position of a first type pixel corresponding to the first gradation value and a position of a second type pixel corresponding to the second gradation value; and
wherein the third gradation value is an average value of a gradation value of the first frame and a gradation value of the second frame.

2. The device as claimed in claim 1, wherein the first gradation value is a minimum gradation value outputtable through the display; and
wherein the second gradation value is a minimum gradation value correctable through a camera that captures the sample image.

3. The device as claimed in claim 1, wherein memory is configured to store a mapping table indicating a sample image corresponding to each of a plurality of gradation values; and
wherein at least one processor is configured to, based on a control command for outputting the third gradation value being received, identify the sample image corresponding to the third gradation value based on the mapping table.

4. The device as claimed in claim 1, wherein at least one processor is configured to:
control the display to display the first frame;
based on a preset time elapsing from a time when the first frame is displayed, control the display to display the second frame.

5. The device as claimed in claim 1, wherein at least one processor is configured to, based on a user control command for correcting a gradation value being received, control the display to sequentially display a sample image corresponding to each of a plurality of gradation values which are greater than the preset first gradation value and less than the preset second gradation value.

6. The device as claimed in claim 1, wherein the gradation value of the first frame is an average gradation value of a plurality of pixels included in the first frame; and
wherein the gradation value of the second frame is an average gradation value of a plurality of pixels included in the second frame.

7. The device as claimed in claim 1, wherein the sample image is an image in which a position of the first type pixel included in the first frame and a position of the first type pixel included in the second frame are different.

8. The device as claimed in claim 1, further comprising:
a communication interface, comprising communication interface circuitry, configured to perform communication with an external device,
wherein at least one processor is configured to:
receive a captured image including the sample image from the external device through the communication interface;
obtain a gradation value of a first pixel group arranged at a first position based on the sample image;
obtain a gradation value of a second pixel group arranged at the first position based on the captured image; and
correct a gradation setting value of the display by comparing a gradation value obtained from the sample image and a gradation value obtained from the captured image.

9. The device as claimed in claim 8, wherein at least one processor is configured to:
obtain a difference value between a gradation value of the first pixel group obtained from the captured image and a gradation value of the second pixel group obtained from the sample image; and
based on the difference value being equal to or greater than a threshold value, obtain a correction filter for changing a gradation value of a pixel group of the first position based on the difference value.

10. The device as claimed in claim 9, wherein at least one processor is configured to:
based on a user input for displaying an input image being received, correct the input image by changing a gradation value of a third pixel group arranged at the first position of the input image based on the correction filter; and
control the display to display the corrected input image.

11. A controlling method of an electronic device that stores a plurality of sample images, the method comprising:
receiving a control command for outputting a third gradation value which is greater than a preset first gradation value and less than a preset second gradation value;
identifying a sample image corresponding to the third gradation value from among the plurality of sample images; and
displaying the identified sample image,
wherein the sample image includes a first frame including a plurality of pixels arranged based on first arrangement information and a second frame including a plurality of pixels arranged based on second arrangement information;
wherein the first arrangement information and the second arrangement information include a position of a first type pixel corresponding to the first gradation value and a position of a second type pixel corresponding to the second gradation value; and
wherein the third gradation value is an average value of the a gradation value of the first frame and a gradation value of the second frame.

12. The method as claimed in claim 11, wherein the first gradation value is a minimum gradation value outputtable through a display of the electronic device; and
wherein the second gradation value is a minimum gradation value correctable through a camera that captures the sample image.

13. The method as claimed in claim 11, wherein the electronic device is configured to store a mapping table indicating a sample image corresponding to each of a plurality of gradation values; and
wherein the identifying a sample image comprises, based on a control command for outputting the third gradation value being received, identifying the sample image corresponding to the third gradation value based on the mapping table.

14. The method as claimed in claim 11, wherein the displaying the sample image comprises:
displaying the first frame; and
based on a preset time elapsing from a time when the first frame is displayed, displaying the second frame.

15. The method as claimed in claim 11, further comprising:
based on a user control command for correcting a gradation value being received, sequentially displaying a sample image corresponding to each of a plurality of gradation values which are greater than the preset first gradation value and less than the preset second gradation value.
